(19) United States
(12) Patent Application Publication
(10) Pub. No.: US 2025/0372307 A1
(43) Pub. Date: Dec. 4, 2025

(54) MULTILAYER CERAMIC CAPACITOR

(71) Applicant: Murata Manufacturing Co., Ltd., Nagaokakyo-shi (JP)

(72) Inventors: Kosuke ONISHI, Nagaokakyo-shi (JP); Ken TOMINAGA, Nagaokakyo-shi (JP); Yukie WATANABE, Nagaokakyo-shi (JP); Satoshi MURAMATSU, Nagaokakyo-shi (JP)

(21) Appl. No.: 19/298,509

(22) Filed: Aug. 13, 2025

Related U.S. Application Data
(63) Continuation of application No. PCT/JP2024/011805, filed on Mar. 26, 2024.

(30) Foreign Application Priority Data
May 11, 2023 (JP) 2023-078299

(51) Int. Cl. H01G 4/252; H01G 4/30

(52) U.S. Cl. CPC H01G 4/252; H01G 4/30

(57) ABSTRACT

A multilayer ceramic capacitor includes a multilayer body and first and second outer electrodes. The first outer electrode includes a first direct plating layer covering the first end surface, a first main surface electrode covering at least a portion of the first main surface, a first upper plating layer, and a first front plating layer, and the second outer electrode includes a second direct plating layer covering a second end surface, a second main surface electrode covering at least a portion of the second main surface, a second upper plating layer, and a second front plating layer.

### CROSS REFERENCE TO RELATED APPLICATIONS

This application claims the benefit of priority to Japanese Patent Application No. 2023-078299 filed on May 11, 2023 and is a Continuation Application of PCT Application No. PCT/JP2024/011805 filed on Mar. 26, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, with the miniaturization of an electronic device including multilayer ceramic capacitors, low-profile multilayer ceramic capacitors are required.

For example, Japanese Unexamined Patent Application Publication No. 2020-136363 discloses a multilayer ceramic capacitor having a dimension in the lamination direction of less than 0.3 mm. In addition, in the multilayer ceramic capacitor described in Japanese Unexamined Patent Application Publication No. 2020-136363, outer electrodes formed on a multilayer body each include a base film that is made from a sintered metal film and a plating film disposed thereon.

To achieve a lower-profile multilayer ceramic capacitor, it is preferable not to provide the outer electrodes on the main surfaces of the multilayer body that face away from each other in the lamination direction, but mountability during mounting may degrade when the outer electrodes are not disposed on the main surfaces.

### SUMMARY OF THE INVENTION

Accordingly, example embodiments of the present invention provide low-profile multilayer ceramic capacitors each without degradation of mountability during mounting.

A multilayer ceramic capacitor according to an example embodiment of the present invention includes a multilayer body including a plurality of laminated dielectric layers, a first main surface and a second main surface that face away from each other in a lamination direction of the plurality of laminated dielectric layers, a first side surface and a second side surface that face away from each other in a width direction orthogonal or substantially orthogonal to the lamination direction, and a first end surface and a second end surface that face away from each other in a length direction orthogonal or substantially orthogonal to the lamination direction and the width direction, a first outer electrode on the first main surface and the first end surface of the multilayer body, and a second outer electrode on the first main surface and the second end surface of the multilayer body, in which the first outer electrode includes a first direct plating layer covering the first end surface, a first main surface electrode covering at least a portion of the first main surface, a first upper plating layer, and a first front plating layer, and the second outer electrode includes a second direct plating layer covering the second end surface, a second main surface electrode covering at least a portion of the first main surface, a second upper plating layer, and a second front plating layer.

According to example embodiments of the present invention, it is possible to achieve low profile by reducing dimensions of multilayer ceramic capacitors in a lamination direction without degradation of mountability during mounting.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating an example of a multilayer ceramic capacitor according to a first example embodiment of the present invention.

FIG. 2 is a front view illustrating the example of the multilayer ceramic capacitor according to the first example embodiment of the present invention.

FIG. 3 is a plan view illustrating the example of the multilayer ceramic capacitor according to the first example embodiment of the present invention.

FIG. 4 is a schematic cross-sectional view taken along line IV-IV in FIG. 1.

FIG. 5 is a schematic cross-sectional view taken along line V-V in FIG. 1.

FIG. 6 is a schematic cross-sectional view taken along line VI-VI in FIG. 1.

FIG. 7 is a schematic cross-sectional view illustrating another example of outer electrodes in the example of the multilayer ceramic capacitor according to the first example embodiment of the present invention.

FIG. 8 is a diagram for describing disposition of a direct plating layer in the example of the multilayer ceramic capacitor according to the first example embodiment of the present invention.

FIG. 9 is a schematic cross-sectional view illustrating another example of the outer electrodes in the example of the multilayer ceramic capacitor according to the first example embodiment of the present invention.

FIG. 10 is a schematic diagram illustrating a structure of main surface electrodes of the outer electrodes of the multilayer ceramic capacitor according to the first example embodiment of the present invention.

FIG. 11 is a schematic diagram illustrating another example of the main surface electrodes of the outer electrodes of the multilayer ceramic capacitor according to the first example embodiment of the present invention.

FIG. 12 is a schematic cross-sectional view illustrating an example of a multilayer ceramic capacitor according to a first modification of the first example embodiment of the present invention.

FIG. 13 is a diagram for describing a measurement method of the example of the multilayer ceramic capacitor according to the first modification of the first example embodiment of the present invention.

FIG. 14 is a schematic cross-sectional view illustrating an example of a multilayer ceramic capacitor according to a second modification of the first example embodiment of the present invention.

FIG. 15 is a schematic cross-sectional view illustrating an example of a multilayer ceramic capacitor according to a third modification of the first example embodiment of the present invention.

FIG. 16 is a schematic cross-sectional view illustrating an example of a multilayer ceramic capacitor according to a fourth modification of the first example embodiment of the present invention.

FIG. 17 is a schematic cross-sectional view illustrating an example of a multilayer ceramic capacitor according to a fifth modification of the first example embodiment of the present invention.

FIG. 18 is a schematic cross-sectional view illustrating an example of a multilayer ceramic capacitor according to a sixth modification of the first example embodiment of the present invention.

FIG. 19 is a perspective view illustrating a multilayer ceramic capacitor that is an example of a multilayer ceramic capacitor according to a second example embodiment of the present invention.

FIG. 20 is a schematic cross-sectional view, taken along line XX-XX in FIG. 19, that illustrates a structure of the example of the multilayer ceramic capacitor according to the second example embodiment of the present invention.

FIG. 21 is a schematic cross-sectional view, taken along line XXI-XXI in FIG. 19, that illustrates the structure of the example of the multilayer ceramic capacitor according to the second example embodiment of the present invention.

FIG. 22 is a schematic cross-sectional view, taken along line XXII-XXII in FIG. 19, that illustrates the structure of the example of the multilayer ceramic capacitor according to second example embodiment of the present invention.

FIG. 23 is a schematic cross-sectional view, taken along line XXIII-XXIII in FIG. 19, that illustrates the structure of the example of the multilayer ceramic capacitor according to second example embodiment of the present invention.

FIG. 24 is a schematic cross-sectional view, taken along line XXIV-XXIV in FIG. 19, that illustrates the structure of the example of the multilayer ceramic capacitor according to second example embodiment of the present invention.

FIG. 25 is an exploded perspective view of a multilayer body illustrated in FIG. 19.

FIG. 26 is a diagram for describing disposition of a direct plating layer in the example of the multilayer ceramic capacitor according to the second example embodiment of the present invention.

FIG. 27 is a perspective view illustrating an example of a multilayer ceramic capacitor according to a first modification of the second example embodiment of the present invention.

FIG. 28 is a schematic cross-sectional view, taken along line XXVIII-XXVIII in FIG. 27, that illustrates a structure of the example of the multilayer ceramic capacitor according to the first modification of the second example embodiment of the present invention.

FIG. 29 is a schematic cross-sectional view, taken along line XXIX-XXIX in FIG. 27, that illustrates the structure of the example of the multilayer ceramic capacitor according to the first modification of the second example embodiment of the present invention.

FIG. 30 is a schematic cross-sectional view, taken along line XXX-XXX in FIG. 27, that illustrates the structure of the example of the multilayer ceramic capacitor according to the first modification of the second example embodiment of the present invention.

FIG. 31 is a schematic cross-sectional view, taken along line XXXI-XXXI in FIG. 27, that illustrates the structure of the example of the multilayer ceramic capacitor according to the first modification of the second example embodiment of the present invention.

FIG. 32 is a schematic cross-sectional view, taken along line XXXII-XXXII in FIG. 27, that illustrates the structure of the example of the multilayer ceramic capacitor according to the first modification of the second example embodiment of the present invention.

FIG. 33 is an exploded perspective view of a multilayer body illustrated in FIG. 27.

FIG. 34 is a perspective view illustrating an example of a multilayer ceramic capacitor according to a second modification of the second example embodiment of the present invention.

FIG. 35 is a perspective view illustrating the example of the multilayer ceramic capacitor according to the second modification of the second example embodiment of the present invention.

FIG. 36 is a schematic cross-sectional view, taken along line XXXVI-XXXVI in FIG. 34, that illustrates a structure of the example of the multilayer ceramic capacitor according to the second modification of the second example embodiment of the present invention.

FIG. 37 is a schematic cross-sectional view, taken along line XXXVII-XXXVII in FIG. 34, that illustrates the structure of the example of the multilayer ceramic capacitor according to the second modification of the second example embodiment of the present invention.

FIG. 38 is a schematic cross-sectional view, taken along line XXXVIII-XXXVIII in FIG. 34, that illustrates the structure of the example of the multilayer ceramic capacitor according to the second modification of the second example embodiment of the present invention.

FIG. 39 is a schematic cross-sectional view, taken along line XXXIX-XXXIX in FIG. 34, that illustrates the structure of the example of the multilayer ceramic capacitor according to the second modification of the second example embodiment of the present invention.

FIG. 40 is a perspective view illustrating an example of a multilayer ceramic capacitor according to a third example embodiment of the present invention.

FIG. 41 is a schematic cross-sectional view, taken along line XXXXI-XXXXI in FIG. 40, that illustrates a structure of an example of the multilayer ceramic capacitor according to the third example embodiment of the present invention.

FIG. 42 is a schematic cross-sectional view, taken along line XXXXII-XXXXII in FIG. 40, that illustrates the structure of the example of the multilayer ceramic capacitor according to the third example embodiment of the present invention.

### DETAILED DESCRIPTION OF THE EXAMPLE EMBODIMENTS

Example embodiments of the present invention will be described in detail below with reference to the drawings.

### A. First Example Embodiment

### 1. Multilayer Ceramic Capacitor

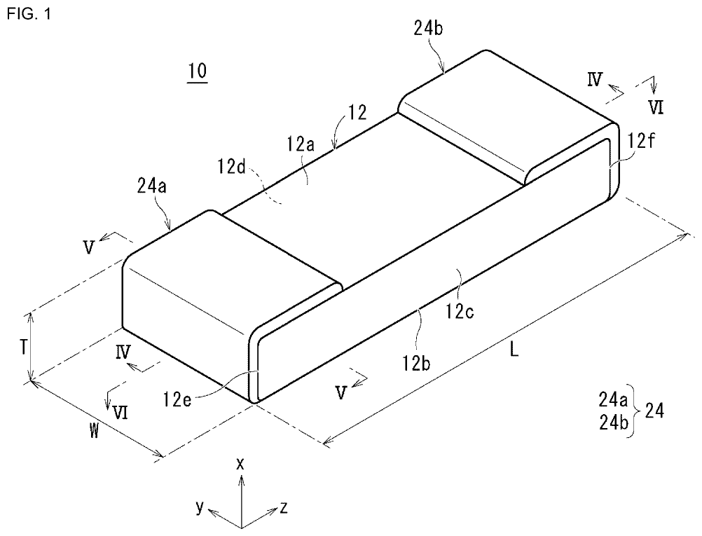

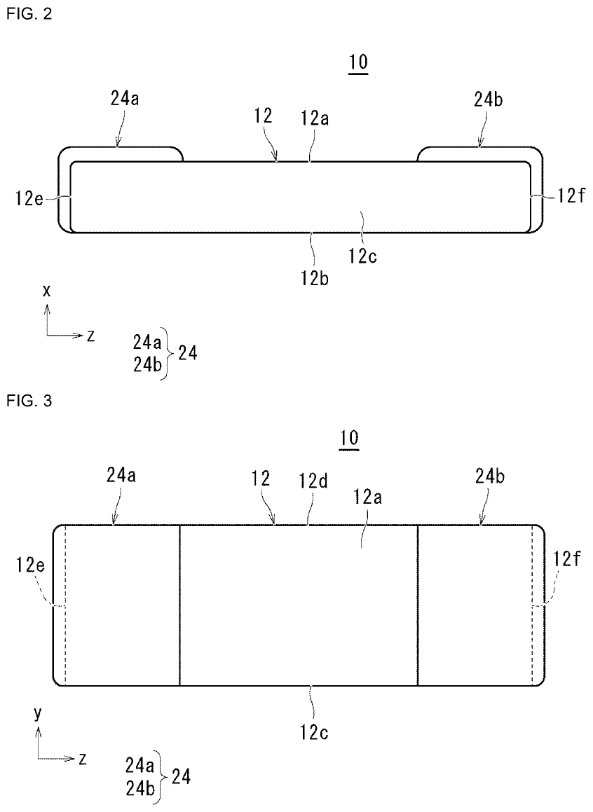

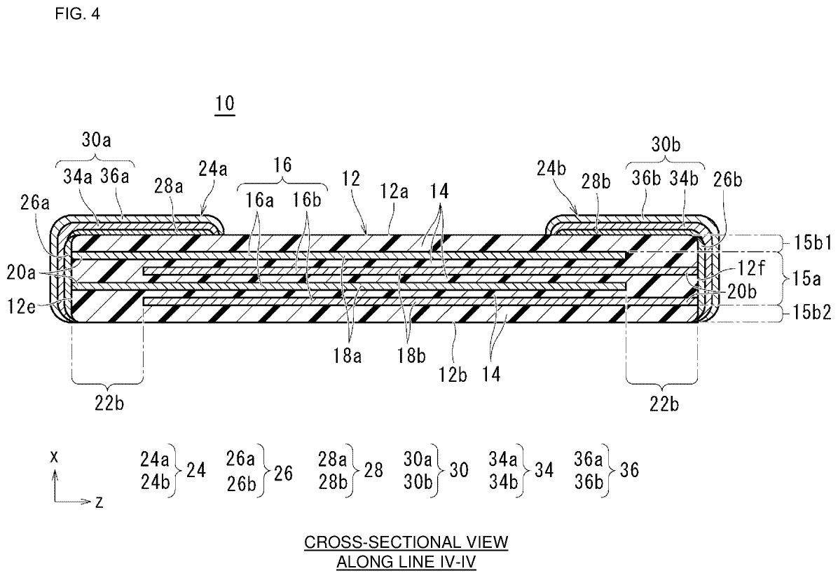

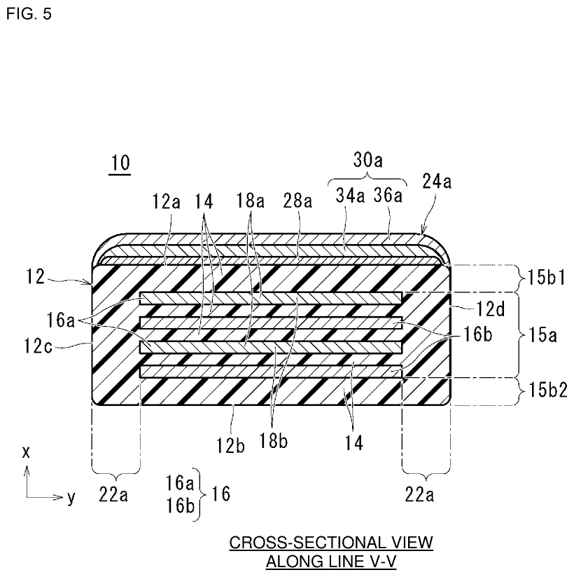

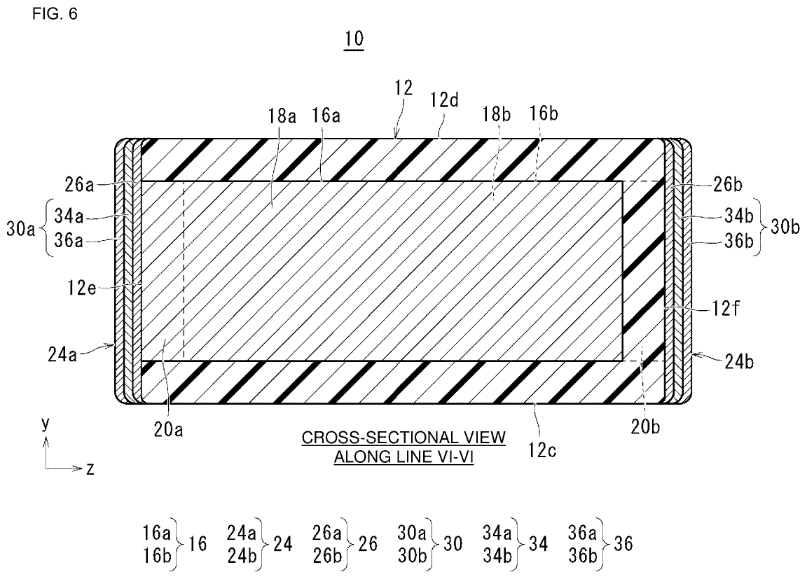

An example of a multilayer ceramic capacitor according to a first example embodiment of the present invention will be described. FIG. 1 is a perspective view illustrating an example of a multilayer ceramic capacitor according to a first example embodiment of the present invention. FIG. 2 is a front view illustrating the example of the multilayer ceramic capacitor according to the first example embodiment of the present invention. FIG. 3 is a plan view illustrating the example of the multilayer ceramic capacitor according to the first example embodiment of the present invention. FIG. 4 is a schematic cross-sectional view taken along line IV-IV in FIG. 1. FIG. 5 is a schematic cross-sectional view taken along line V-V in FIG. 1. FIG. 6 is a schematic cross-sectional view taken along line VI-VI in FIG. 1.

The multilayer ceramic capacitor 10 includes a multilayer body 12 and an outer electrode 24. The structure of the multilayer body 12 and the structure of the outer electrode 24 will be described below in this order.

### Multilayer Body

The multilayer body 12 includes a plurality of laminated dielectric layers 14 and a plurality of inner electrode layers 16. In addition, the multilayer body 12 includes a first main surface 12a and a second main surface 12b that face away from each other in a height direction x in which the plurality of dielectric layers 14 are laminated together, a first side surface 12c and a second side surface 12d that face away from each other in a width direction y orthogonal or substantially orthogonal to the height direction x, a first end surface 12e and a second end surface 12f that face away from each other in a length direction z orthogonal or substantially orthogonal to the height direction x and the width direction y. The multilayer body 12: includes rounded corner portions and rounded ridge line portions. Each of the corner portions refers to a portion at which three adjacent surfaces of the multilayer body 12 intersect each other, and each of the ridge line portions refers to a portion at which two adjacent surfaces of the multilayer body 12 intersect each other. In addition, bumps and dips and the like may be provided on some or all of the first main surface 12a and the second main surface 12b, the first side surface 12c and the second side surface 12d, and the first end surface 12e and the second end surface 12f. One or both of the first main surface 12a and the second main surface 12b are preferably flat. Since the stress received from the nozzle that picks up the multilayer ceramic capacitor 10 can be distributed on flat surfaces when one or both of them are flat, the strength of the multilayer ceramic capacitor 10 during mounting can be improved. As illustrated in FIGS. 4 and 5, in the height direction x in which the first main surface 12a and the second main surface 12b are connected to each other, the multilayer body 12 includes an effective layer portion 15a in which the plurality of inner electrode layers 16 face each other, a first outer layer portion 15b1 including the plurality of dielectric layers 14 located between the inner electrode layer 16 closest to the first main surface 12a and the first main surface 12a, and a second outer layer portion 15b2 including the plurality of dielectric layers 14 located between the inner electrode layer 16 closest to the second main surface 12b and the second main surface 12b.

The first outer layer portion 15b1 is located close to the first main surface 12a of the multilayer body 12 and is an aggregation of the plurality of dielectric layers 14 located between the first main surface 12a and the inner electrode layer 16 closest to the first main surface 12a.

The second outer layer portion 15b2 is located close to the second main surface 12b of the multilayer body 12 and is an aggregation of the plurality of dielectric layers 14 located between the second main surface 12b and the inner electrode layer 16 closest to the second main surface 12b.

In addition, the region sandwiched between the first outer layer portion 15b1 and the second outer layer portion 15b2 is the effective layer portion 15a.

The multilayer body 12 includes side portions 22a (W gaps) of the multilayer body 12 that are located between the inner electrode layer 16 and the first side surface 12c and between the inner electrode layer 16 and the second side surface 12d. In addition, the multilayer body 12 includes end portions 22b (L gaps) of the multilayer body 12 that are located between the inner electrode layer 16 and the first end surface 12e and between the inner electrode layer 16 and the second end surface 12f.

The number of dielectric layers 14 to be laminated is not particularly limited, but, for example, a total of 3 to 700 layers is preferable, including the effective layer portion 15a, the first outer layer portion 15b1, and the second outer layer portion 15b2. In addition, the thickness of the effective layer portion 15a is, for example, preferably about 0.4 μm or more and about 2.0 μm or less, and the thickness of the first outer layer portion 15b1 and the second outer layer portion 15b2 is, for example, preferably about 2.0 μm or more and about 100.0 μm or less.

The thinner the dielectric layers 14, the greater the capacitance in the capacitor, and accordingly, for example, a crystal grain diameter of about 1 μm or less is preferable.

The material of the dielectric layer 14 may be, for example, a dielectric material. The dielectric material may be dielectric ceramic including, for example, BaTiO₃, CaTiO₃, SrTiO₃, or CaZrO₃ as main components. In addition, depending on the desired characteristics of the multilayer body, accessory components with lower content than main components, such as, for example, Mn compounds, Fe compounds, Cr compounds, Co compounds, or Ni compounds, may be added.

The dielectric layer 14 may include, for example, a plurality of crystal grains that include a perovskite compound including BaTiO₃ as the fundamental structure.

Here, the plurality of inner layer dielectric layers 14 for inner layers that define the effective layer portion 15a are provided so as to be sandwiched between first inner electrode layers 16a and second inner electrode layers 16b of the plurality of inner electrode layers 16. The dielectric layer 14 for inner layers includes dielectric ceramic particles including, as main components, perovskite compounds including, for example, Ba and Ti and have a perovskite structure. In addition, at least one of Si, Mg, Ba, or Mn may be added as an additive to these main components. The additive is present between the ceramic particles.

The dielectric layers 14 for outer layers that define the first outer layer portion 15b1 and the second outer layer portion 15b2 are made of the same dielectric ceramic material as the dielectric layer 14 for inner layers. The dielectric layers 14 for outer layers may be made of a material different from that of the dielectric layers 14 for inner layers. In addition, when the dielectric layer 14 for the first outer layer portion 15b1 and the dielectric layer 14 for the second outer layer portion 15b2 each have a multilayer structure, the segregation portions in the dielectric layers 14 located closest to the first inner electrode layer 16a and the second inner electrode layer 16b are preferably less than Si segregation portions in the other dielectric layers 14 for outer layers. As a result, the deflective strength of the multilayer ceramic capacitor in the height direction x can be improved. The dielectric layer 14 for the first outer layer portion 15b1 and the dielectric layer 14 for the second outer layer portion 15b2 may each have a multilayer structure or a single-layer structure. In addition, the present invention is not limited to this example, and the first outer layer portion 15b1 and the second outer layer portion 15b2 may include, for example, a DLC film or a heterogeneous insulating material of insulating resins.

### Inner Electrode Layer

As illustrated in FIGS. 4 and 5, the inner electrode layer 16 includes the first inner electrode layer 16a and the second inner electrode layer 16b. The first inner electrode layer 16a and the second inner electrode layer 16b are alternately laminated via the dielectric layer 14.

The first inner electrode layer 16a is disposed on the surface of the dielectric layer 14. The first inner electrode layer 16a includes a first opposed electrode portion 18a that faces the second inner electrode layer 16b and a first extended electrode portion 20a, located close to one end of the first inner electrode layer 16a, that extends from the first opposed electrode portion 18a to the first end surface 12e of the multilayer body 12. An end portion of the first extended electrode portion 20a extends to and is exposed to the first end surface 12e.

The shape of the first opposed electrode portion 18a of the first inner electrode layer 16a is not particularly limited but is, for example, preferably rectangular or substantially rectangular in plan view. However, the corner portions may be rounded in plan view, or the corner portions may extend diagonally (be tapered) in plan view. Alternatively, the shape may be tapered in plan view that inclines toward either side.

The shape of the first extended electrode portion 20a of the first inner electrode layer 16a is not particularly limited but is, for example, preferably rectangular or substantially rectangular in plan view. However, the corner portions may be rounded in plan view, or the corner portions may extend diagonally (be tapered) in plan view. Alternatively, the shape may be a tapered shape in plan view that inclines toward either side.

The width of the first opposed electrode portion 18a of the first inner electrode layer 16a may be the same or substantially the same as the width of the first extended electrode portion 20a of the first inner electrode layer 16a, or one of these widths may be smaller than the other.

The second inner electrode layer 16b is disposed on the surface of a dielectric layer 14 that differs from the dielectric layer 14 on which the first inner electrode layer 16a is disposed. The second inner electrode layer 16b includes a second opposed electrode portion 18b that faces the first inner electrode layer 16a and a second extended electrode portion 20b, located close to one end of the second inner electrode layer 16b, that extends from the second opposed electrode portion 18b to the second end surface 12f of the multilayer body 12 are present. An end portion of the second extended electrode portion 20b is extended and exposed to the second end surface 12f.

The shape of the second opposed electrode portion 18b of the second inner electrode layer 16b is not particularly limited but is, for example, preferably rectangular or substantially rectangular in plan view. However, the corner portions may be rounded in plan view, or the corner portions may extend diagonally (be tapered) in plan view. Alternatively, the shape may be a tapered shape in plan view that inclines toward either side.

The shape of the second extended electrode portion 20b of the second inner electrode layer 16b is not particularly limited but is, for example, preferably rectangular or substantially rectangular in plan view. However, the corner portions may be rounded in plan view, or the corner portions may extend diagonally (be tapered) in plan view. Alternatively, the shape may be a tapered shape in plan view that inclines toward either side.

The width of the second opposed electrode portion 18b of the second inner electrode layer 16b may be the same or substantially the same as the width of the second extended electrode portion 20b of the second inner electrode layer 16b, or one of these widths may be smaller than the other.

The number of inner electrode layers 16 to be laminated is not particularly limited, but, for example, a total of 2 to 700 layers is preferable. In addition, the thickness of the inner electrode layer 16 is, for example, preferably about 0.2 μm or more and about 2.0 μm or less.

The first inner electrode layer 16a and the second inner electrode layer 16b may be made of an appropriate conductive material, such as, for example, a metal including Ni, Cu, Ag, Pd, or Au, or an alloy including at least one of these metals, such as an Ag—Pd alloy, but the present invention is not limited to this example. In the present example embodiment, the first opposed electrode portion 18a of the first inner electrode layer 16a faces the second opposed electrode portion 18b of the second inner electrode layer 16b via the dielectric layer 14, and accordingly, electrostatic capacitance is generated and the characteristics of the capacitor provided.

### Outer Electrode

The outer electrodes 24 are disposed on the side of the multilayer body 12 close to the first end surface 12e and on the side of the multilayer body 12 close to the second end surface 12f, as illustrated in FIGS. 1 to 6.

The outer electrode 24 includes a direct plating layer 26, a main surface electrode 28, and a plating layer 30 covering the direct plating layer 26 and the main surface electrode 28.

The outer electrode 24 includes a first outer electrode 24a and a second outer electrode 24b.

The first outer electrode 24a is disposed on a portion of the first main surface 12a and a portion of the first end surface 12e of the multilayer body 12. In this case, the first outer electrode 24a is electrically connected to the first extended electrode portion 20a of the first inner electrode layer 16a. The first outer electrode 24a may wrap around a portion of the first side surface 12c and a portion of the second side surface 12d.

The second outer electrode 24b is disposed on a portion of the first main surface 12a and a portion of the second end surface 12f of the multilayer body 12. In this case, the second outer electrode 24b is electrically connected to the second extended electrode portion 20b of the second inner electrode layer 16b. The second outer electrode 24b may wrap around a portion of the first side surface 12c and a portion of the second side surface 12d.

### Direct Plating Layer

The direct plating layer 26 includes a first direct plating layer 26a and a second direct plating layer 26b.

The first direct plating layer 26a of the direct plating layer 26 is disposed so as to coat the first end surface 12e of the multilayer body 12. The first direct plating layer 26a is electrically connected directly to the first extended electrode portion 20a of the first inner electrode layer 16a.

The upper end of the first direct plating layer 26a is disposed so as to overlap the lower side of a first main surface electrode 28a on the ridge line portion provided by the first main surface 12a and the first end surface 12e of the multilayer body 12.

The second direct plating layer 26b of the direct plating layer 26 is disposed so as to coat the second end surface 12f of the multilayer body 12. The second direct plating layer 26b is electrically connected directly to the second extended electrode portion 20b of the second inner electrode layer 16b.

The upper end of the second direct plating layer 26b is disposed so as to overlap the lower side of a second main surface electrode 28b on the ridge line portion provided by the first main surface 12a and the second end surface 12f of the multilayer body 12.

The direct plating layer 26 is not particularly limited as long as the direct plating layer 26 includes at least one metal selected from, for example, Cu, Ni, Ag, Pd, Ag—Pd alloy, or Au as a main metallic component. When the first inner electrode layer 16a and the second inner electrode layer 16b include, for example, Ni, Cu plating having good bondability with Ni is preferably used as the direct plating layer 26.

The direct plating layer 26 is formed such that plating grows from the inner electrode layer 16 and covers the first end surface 12e and the second end surface 12f.

The thickness of each of the direct plating layers 26 is, for example, preferably about 2.0 μm or more and about 10.0 μm or less.

### Main Surface Electrode

The main surface electrode 28 includes the first main surface electrode 28a and the second main surface electrode 28b.

The first main surface electrode 28a is disposed so as to cover a portion of the first main surface 12a close to the first end surface 12e of the multilayer body 12 without covering the first end surface 12e of the multilayer body 12.

The second main surface electrode 28b is disposed so as to cover a portion of the first main surface 12a close to the second end surface 12f of the multilayer body 12 without covering the second end surface 12f of the multilayer body 12.

The first main surface electrode 28a and the second main surface electrode 28b preferably include deposition of metal particles formed by a thin film formation method, such as a sputtering method, for example. As a result, since the thicknesses of the first main surface electrode 28a to the fourth main surface electrode 28b in the direction in which the first main surface 12a and the second main surface 12b of the multilayer body 12 are connected to each other can be, for example, about 1 μm or less and the dimension of the multilayer ceramic capacitor 10 in the height direction x can be sufficiently small, low profile can be achieved.

The dimensions of the first main surface electrode 28a and the second main surface electrode 28b in the height direction x can be measured as described below. That is, when the main surface electrodes are formed by the deposition of metal particles as described above, it is possible to use a method that performs thickness conversion from the concentration of a predetermined element by using, for example, the calibration curve method of the corresponding metal that uses a fluorescent X-ray device. In other cases, for example, a cross-section of a component by FIB can be observed by using a scanning electron microscope, and the thickness can be measured from an actual observation image.

In addition, when the first main surface electrode 28a and the second main surface electrode 28b are formed by a thin film formation method, these main surface electrodes can be made of a metal, such as, for example, Cu, Cr, Au, Pt, Ag, Sn, Ti, or Ni.

The first main surface electrode 28a and the second main surface electrode 28b can be configured in consideration of their respective functions. For example, the main surface electrodes can be made of NiCr or the like in consideration of the degree of close contact with the multilayer body 12.

In addition, when the first main surface electrode 28a and the second main surface electrode 28b include the same main component as the dielectric layer 14, the degree of close contact can be further improved by simultaneously burning the multilayer body 12 and the first and second main surface electrodes 28a and 28b. In this case, for example, Ni, Cu, or the like are preferable provided as the metal components, but the metal components can be changed as appropriate according to the metal components of the inner electrode layer 16.

### Plating Layer

The plating layer 30 includes a first plating layer 30a and a second plating layer 30b.

The first plating layer 30a is disposed so as to coat the first main surface electrode 28a and the first end surface 12e of the multilayer body 12.

The second plating layer 30b is disposed so as to coat the second main surface electrode 28b and the second end surface 12f of the multilayer body 12.

The plating layer 30 includes a plurality of layers. That is, the plating layer 30 includes an upper plating layer 34 and a front plating layer 36.

The upper plating layer 34 includes a first upper plating layer 34a included in the first plating layer 30a and a second upper plating layer 34b included in the second plating layer 30b. The front plating layer 36 includes a first front plating layer 36a included in the first plating layer 30a and a second front plating layer 36b included in the second plating layer 30b.

The first upper plating layer 34a of the upper plating layer 34 is disposed so as to coat the first direct plating layer 26a of the direct plating layer 26 and the first main surface electrode 28a.

The second upper plating layer 34b of the upper plating layer 34 is disposed so as to coat the second direct plating layer 26b of the direct plating layer 26 and the second main surface electrode 28b.

The upper plating layer 34 is, for example, preferably Ni plating to prevent elution to solder.

The first front plating layer 36a of the front plating layer 36 is disposed so as to cover the first upper plating layer 34a of the upper plating layer 34.

The second front plating layer 36b of the front plating layer 36 is disposed so as to cover the second upper plating layer 34b of the upper plating layer 34.

The front plating layer 36 is, for example, preferably Sn plating having good bondability with the solder used to mount the multilayer ceramic capacitor 10. In addition, the front plating layer 36 may also be, for example, Cu plating. In this case, it is possible to improve the bondability with the vias formed when the multilayer ceramic capacitor 10 is embedded in the mounting substrate.

The plating layer 30 may be provided solely of the front plating layer 36. In this case, the first front plating layer 36a of the front plating layer 36 is disposed so as to coat the first direct plating layer 26a and the first main surface electrode 28a, and the second front plating layer 36b of the front plating layer 36 is disposed so as to coat the second direct plating layer 26b and the second main surface electrode 28b.

The ratio of metal per unit volume of the plating layer 30 is, for example, preferably about 99 vol % or more.

The thickness of each of the plating layers 30 is, for example, preferably about 1.0 μm or more and about 10.0 μm or less.

The dimension in the length direction z of the multilayer ceramic capacitor 10 including the multilayer body 12, the first outer electrode 24a, and the second outer electrode 24b is defined as an L-dimension, the dimension in the height direction x of the multilayer ceramic capacitor 10 including the multilayer body 12, the first outer electrode 24a, and the second outer electrode 24b is defined as a T-dimension, and the dimension in the width direction y of the multilayer ceramic capacitor 10 including the multilayer body 12, the first outer electrode 24a, and the second outer electrode 24b is defined as a W-dimension.

The dimensions of the multilayer ceramic capacitor 10 are, for example, preferably as follows: the L-dimension in the length direction z is about 0.2 mm or more and about 3.2 mm or less, the T-dimension in the height direction x is about 40 μm or more and about 300 μm or less, and the W-dimension in the width direction y is about 0.1 mm or more and about 2.5 mm or less. In the multilayer ceramic capacitor 10 illustrated in FIG. 1, the L-dimension is larger than the W-dimension.

More preferably, the T-dimension of the multilayer ceramic capacitor 10 is, for example, about 100 μm or less. Even more preferably, the T-dimension of the multilayer ceramic capacitor 10 is, for example, about 60 μm or less.

In the multilayer ceramic capacitor 10 according to the first example embodiment illustrated in FIG. 1, the first main surface electrode 28a is disposed on the first main surface 12a of the multilayer body 12, and the second main surface electrode 28b is disposed on the first main surface 12a of the multilayer body 12 in the outer electrode 24. In addition, the outer electrode 24 and the inner electrode layer 16 are electrically connected to each other via the direct plating layer 26.

As a result, since the thickness (T-dimension) in the height direction x of the outer electrode 24 can be reduced with the outer electrode 24 disposed on the first main surface 12a, a low-profile multilayer ceramic capacitor can be provided without degradation of mountability during mounting.

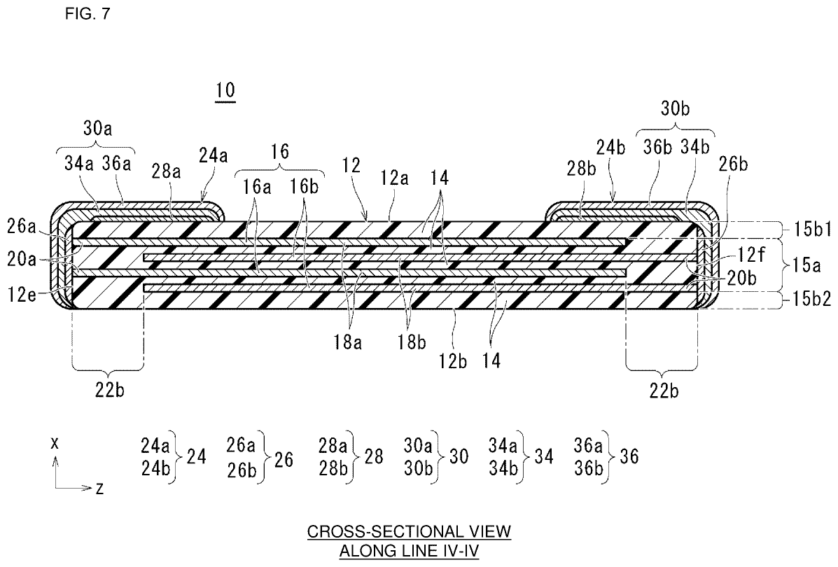

As illustrated in FIG. 4, the upper end of the first direct plating layer 26a of the direct plating layer 26 is disposed so as to overlap the lower side of the first main surface electrode 28a on the ridge line portion provided by the first main surface 12a and the first end surface 12e of the multilayer body 12, and the upper end of the second direct plating layer 26b of the direct plating layer 26 is disposed so as to overlap the lower side of the second main surface electrode 28b on the ridge line portion provided by the first main surface 12a and the second end surface 12f of the multilayer body 12. However, as illustrated in FIG. 7, the upper ends of the first direct plating layer 26a and the second direct plating layer 26b of the direct plating layer 26 may be spaced apart from the first main surface electrode 28a and the second main surface electrode 28b, respectively.

As a result, since the thickness in the lamination direction of the outer electrode 24 provided on the first main surface 12a can be further reduced, a lower-profile multilayer ceramic capacitor can be provided without degradation of mountability during mounting.

In addition, when the direct plating layer 26 and the main surface electrode 28 are spaced apart from each other on the first main surface 12a, the distance between the direct plating layer 26 and the main surface electrode 28 along the shape of the multilayer body 12 is, for example, preferably 10 μm or less. In the disposition at this distance, the upper plating layer 34 can be uniformly provided on the first main surface 12a.

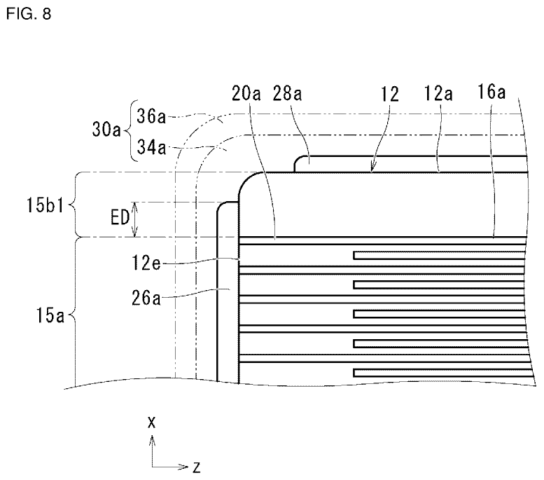

Here, in the first direct plating layer 26a illustrated in FIG. 8 as an example, a distance ED between the first direct plating layer 26a and a portion, exposed to the first end surface 12e, of the first extended electrode portion 20a of the first inner electrode layer 16a that is the inner electrode layer 16 closest to the first main surface 12a of the multilayer body 12 is, for example, preferably about 1 μm or more and about 20 μm or less along the shape of the multilayer body 12. More preferably, the distance ED is smaller than the thickness of the outer layer portion (the first outer layer portion 15b1 in FIG. 8) at the center of the multilayer body 12 in the length direction z and the width direction y. As a result, the dimension in the lamination direction x can be reduced. The same applies to the side close to the second main surface 12b.

In the range described above, it is possible to reduce the amount of overlap with the first main surface 12a at the upper end of the first direct plating layer 26a while reducing or preventing moisture intrusion into the first end surface 12e of the multilayer body 12. That is, when the dimension in the height direction x of the first outer layer portion 15b1 close to the first main surface 12a is, for example, about 20 μm or more, the first direct plating layer 26a does not substantially overlap the first main surface 12a.

On the other hand, when the upper end of the first direct plating layer 26a extends to the first main surface 12a of the multilayer body 12 and overlaps the first main surface electrode 28a, the first main surface electrode 28a may cover a portion of the first direct plating layer 26a from an end portion on the central side of the multilayer body 12 to 100% or less of the first direct plating layer 26a. That is, the first main surface electrode 28a may completely coat the first direct plating layer 26a in the length direction z as viewed in the height direction x.

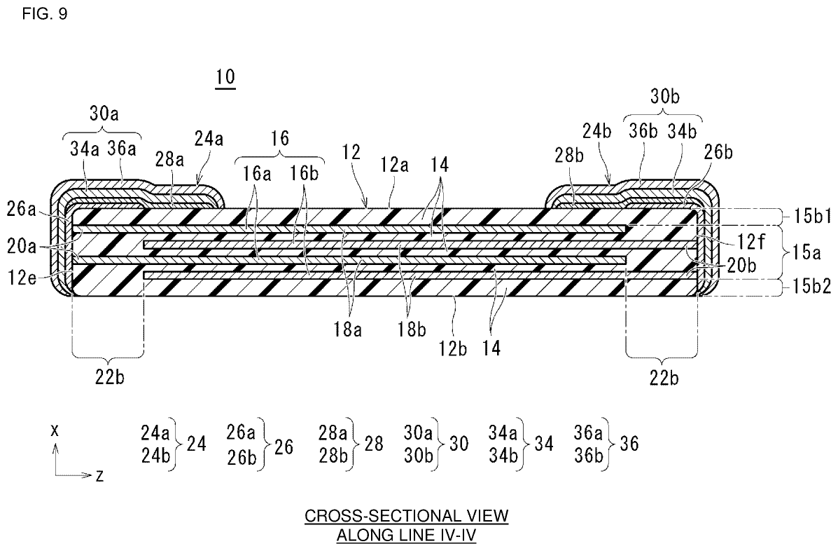

In addition, as illustrated in FIG. 9, the upper end of the first direct plating layer 26a of the direct plating layer 26 may extend onto the first main surface 12a across the ridge line portion provided by the first main surface 12a and the first end surface 12e of the multilayer body 12 and define the lower layer of the first main surface electrode 28a. Similarly, the upper end of the second direct plating layer 26b of the direct plating layer 26 may also extend onto the first main surface 12a across the ridge line portion provided by the first main surface 12a and the second end surface 12f of the multilayer body 12 and define the lower layer of the second main surface electrode 28b. As a result, moisture intrusion from the external environment can be effectively reduced or prevented. The present invention is not limited to this example, and the upper end of the first direct plating layer 26a of the direct plating layer 26 may extend onto the second main surface 12b across the ridge line portion provided by the second main surface 12b and the first end surface 12e of the multilayer body 12. Similarly, the upper end of the second direct plating layer 26b of the direct plating layer 26 may also extend onto the second main surface 12b across the ridge line portion provided by the second main surface 12b and the second end surface 12f of the multilayer body 12.

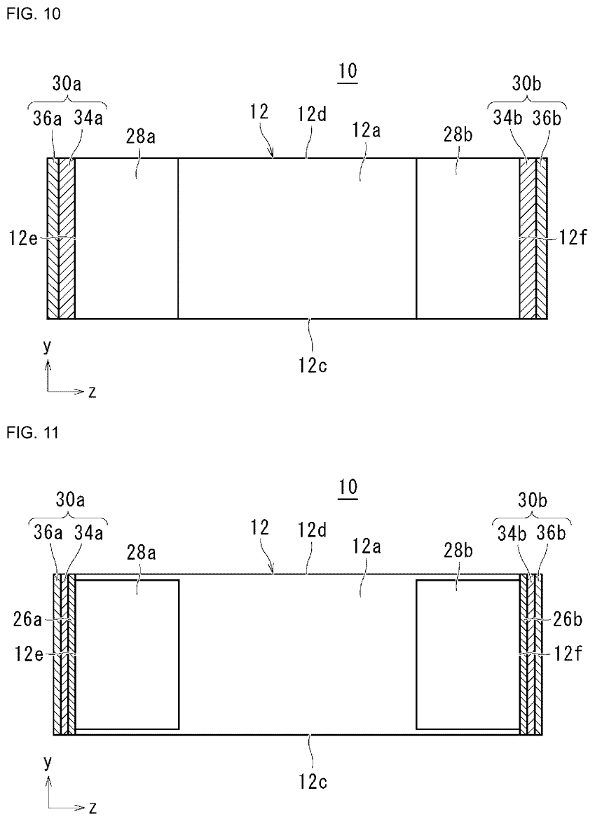

In addition, as illustrated in FIG. 10, in the multilayer ceramic capacitor 10 according to the present example embodiment, the dimensions of the first main surface electrode 28a and the second main surface electrode 28b in the direction (width direction y) in which the first side surface 12c and the second side surface 12d of the multilayer body 12 are connected to each other as viewed in the height direction x are the same or substantially the same as the dimension of the direct plating layer 26 in the width direction y, but the present invention is not limited to this example.

That is, as illustrated in FIG. 11, in the multilayer ceramic capacitor 10 according to the present example embodiment, the dimensions of the first main surface electrode 28a and the second main surface electrode 28b in the width direction y as viewed in the height direction x may be smaller than the dimension of the direct plating layer 26.

### (1) First Modification

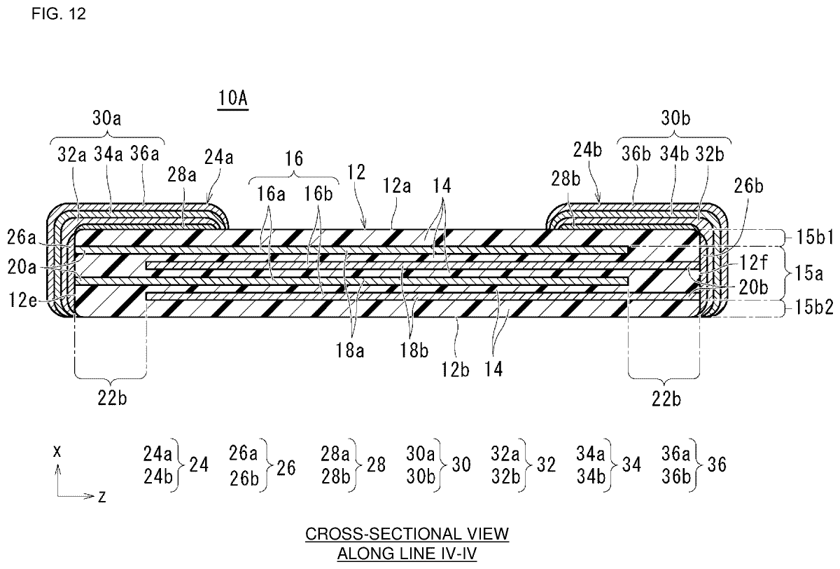

Next, an example of a multilayer ceramic capacitor 10A according to a first modification of the first example embodiment of the present invention will be described. FIG. 12 is a schematic cross-sectional view illustrating the example of the multilayer ceramic capacitor according to the first modification of the first example embodiment of the present invention. However, components that are the same as or correspond to those in FIGS. 1 to 11 are denoted by the same reference numerals and detailed descriptions are omitted.

As illustrated in FIG. 12, in the multilayer ceramic capacitor 10A according to the first modification, the plating layer 30 of the outer electrode 24 further includes a lower plating layer 32 disposed between the direct plating layer 26 and the upper plating layer 34. As a result, the upper plating layer 34 of the plating layer 30 indirectly coats the direct plating layer 26 and the main surface electrode 28 via the lower plating layer 32.

The lower plating layer 32 includes a first lower plating layer 32a included in the first plating layer 30a and a second lower plating layer 32b included in the second plating layer 30b.

The first lower plating layer 32a is disposed so as to coat the first main surface electrode 28a and the first direct plating layer 26a.

The second lower plating layer 32b is disposed so as to coat the second main surface electrode 28b and the second direct plating layer 26b.

The main metallic component of the lower plating layer 32 is preferably the same as the main metallic component of the direct plating layer 26. For example, when the direct plating layer 26 is Cu plating, the lower plating layer 32 is preferably Cu plating.

When the main metallic component of the lower plating layer 32 is the same as the main metallic component of the direct plating layer 26, corrosion due to the battery action or effect between different metals is reduced or prevented.

Since the multilayer ceramic capacitor 10A further includes the lower plating layer 32 as described above, moisture intrusion from the external environment can be reduced or prevented.

The main metallic component of the lower plating layer 32 may differ from the main metallic component of the direct plating layer 26. For example, when the direct plating layer 26 is Cu plating, if the lower plating layer 32 is Sn plating, the lower plating layer 32 defines a barrier layer that reduces or prevents moisture intrusion, and the moisture resistance of the multilayer ceramic capacitor 10A can be improved.

The thickness of the lower plating layer 32 is, for example, preferably about 10% or more and about 100% or less of the thickness of the direct plating layer 26. When the thickness is, for example, less than about 10%, a continuous plating film cannot be easily formed. Alternatively, when the thickness is, for example, greater than 100%, reduction or prevention effects due to the thickness cannot be easily obtained.

In addition, the specific thickness of the direct plating layer 26 is, for example, preferably about 1 μm or more and about 10 μm or less, and the specific thickness of the lower plating layer 32 is, for example, preferably about 3 μm or more and about 8 μm or less.

As a result, in the multilayer ceramic capacitor 10A, moisture intrusion from the external environment can be blocked by the lower plating layer 32.

In addition, the metal particle diameter of the lower plating layer 32 is, for example, preferably about 10% or more and about 100% or less of the metal particle diameter of the direct plating layer 26. That is, since the metal particle diameter of the lower plating layer 32 is smaller than the metal particle diameter of the direct plating layer 26, moisture intrusion from the external environment can be effectively reduced or prevented.

The metal particle diameter of the lower plating layer 32 can be measured, for example, by using the following measurement method.

In an example in which the lower plating layer 32 is Cu plating, cross-sectional polishing is performed on the multilayer ceramic capacitor 10A by about ½ of the W-dimension in the width direction y of the multilayer body 12 to obtain a ½LT cross section.

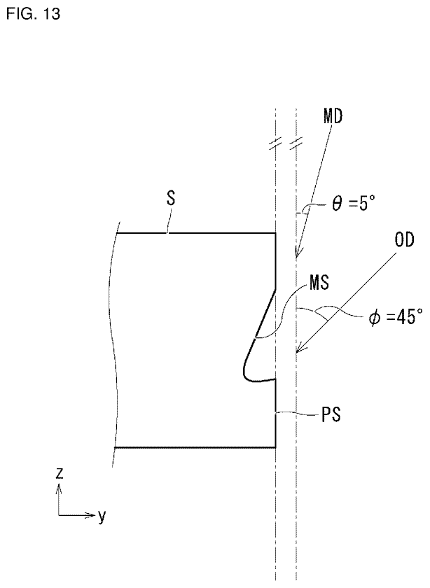

Then, as illustrated in FIG. 13, the lower plating layer 32 included in the ½LT cross section (polished surface) PS of a sample S is machined by a FIB using the machine XVision (manufactured by Hitachi High-Tech Corporation) in a direction MD of angle θ that satisfies angle θ=about 5° with respect to the height direction x that corresponds to the polished surface PS, and the machined surface MS is obtained. Then, the machined surface MS is observed in a direction OD of angle φ that satisfies φ=about 45° with respect to the height direction x. The observation is performed by a scanning ion microscope (SIM), which is a microscope that generates an image by capturing secondary electrons generated during Ga ion beam scanning.

Particles of Cu plating can be captured by performing the observation with an observation field of about 15 μm×about 15 μm at a magnification of about 12,000 times. The particle diameter of the lower plating layer 32 is defined as the average particle diameter of observed particles.

In the multilayer ceramic capacitor 10A according to the first modification illustrated in FIG. 12, the same or substantially the same advantageous effects as the multilayer ceramic capacitor 10 in FIG. 1 are obtained. In addition, moisture intrusion from the external environment can be reduced or prevented.

### (2) Second Modification

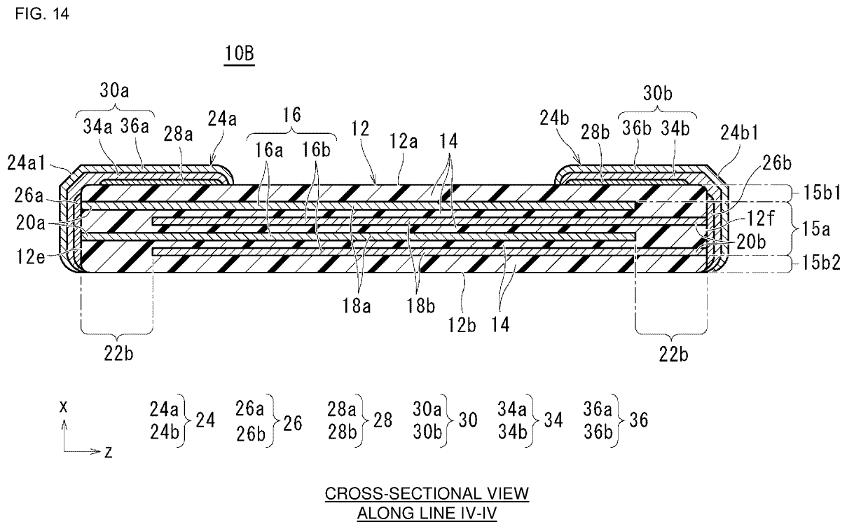

Next, an example of a multilayer ceramic capacitor 10B according to a second modification of the first example embodiment of the present invention will be described. FIG. 14 is a schematic cross-sectional view illustrating the example of the multilayer ceramic capacitor according to the second modification of the first example embodiment of the present invention. However, components that are the same as or correspond to those in FIGS. 1 to 11 are denoted by the same reference numerals and detailed descriptions are omitted.

In the multilayer ceramic capacitor 10B according to the second modification, as illustrated in FIG. 14, the first main surface electrode 28a and the second main surface electrode 28b are spaced apart from the first direct plating layer 26a and the second direct plating layer 26b, respectively, of the direct plating layer. In addition, the portions corresponding to the ridge line portions of the outer electrode 24, which are the portion that covers the ridge line portion provided by the first main surface 12a and the first end surface 12e of the multilayer body 12 and the portion that covers the ridge line portion provided by the first main surface 12a and the second end surface 12f of the multilayer body 12 in the outer electrode 24, are formed as inclined surfaces. The first main surface electrode 28a and the second main surface electrode 28b may be spaced apart from or may overlap the first direct plating layer 26a and the second direct plating layer 26b, respectively, of the direct plating layer.

Specifically, the first outer electrode 24a includes a portion corresponding to the ridge line portion provided by the first main surface 12a and the first end surface 12e, as a first inclined surface 24a1 that has a depression angle from the first main surface 12a toward the first end surface 12e. In addition, the second outer electrode 24b includes a portion corresponding to the ridge line portion provided by the first main surface 12a and the second end surface 12f, as a second inclined surface 24b1 that has a depression angle from the first main surface 12a toward the second end surface 12f.

In the multilayer ceramic capacitor 10B according to the second modification illustrated in FIG. 14, as in the multilayer ceramic capacitor 10 in FIG. 1, a low-profile multilayer ceramic capacitor can be provided without degradation of mountability during mounting. In addition, the durability of the multilayer ceramic capacitor can be improved by distributing the stress applied to the ridge line portion of the outer electrode 24.

### (3) Third Modification

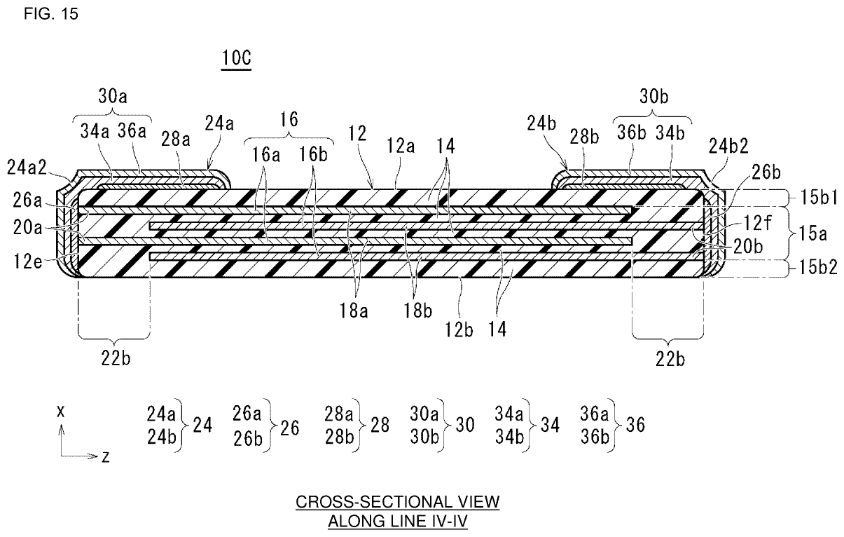

Next, an example of a multilayer ceramic capacitor 10C according to a third modification of the first example embodiment of the present invention will be described. FIG. 15 is a schematic cross-sectional view illustrating the example of the multilayer ceramic capacitor according to the third modification of the first example embodiment of the present invention. However, components that are the same as or correspond to those in FIGS. 1 to 11 are denoted by the same reference numerals and detailed descriptions are omitted.

In the multilayer ceramic capacitor 10C according to the third modification, as illustrated in FIG. 15, the first main surface electrode 28a and the second main surface electrode 28b are spaced apart from the first direct plating layer 26a and the second direct plating layer 26b, respectively. In addition, the portions corresponding to the ridge line portions of the outer electrode 24, which are the portion that covers the ridge line portion provided by the first main surface 12a and the first end surface 12e of the multilayer body 12 and the portion that covers the ridge line portion formed by the first main surface 12a and the second end surface 12f of the multilayer body 12 in the outer electrode 24, are provided as curved surfaces recessed as viewed in the width direction y. The first main surface electrode 28a and the second main surface electrode 28b may be spaced apart from or may overlap the first direct plating layer 26a and the second direct plating layer 26b, respectively, of the direct plating layer.

Specifically, the first outer electrode 24a includes the portion corresponding to the ridge line portion provided by the first main surface 12a and the first end surface 12e, as a first concave surface 24a2 extending from the first main surface 12a toward the first end surface 12e. In addition, the second outer electrode 24b includes the portion corresponding to the ridge line portion formed by the first main surface 12a and the second end surface 12f, as a second concave surface 24b2 extending from the first main surface 12a toward the second end surface 12f.

In the multilayer ceramic capacitor 10C according to the third modification illustrated in FIG. 15, as in the multilayer ceramic capacitor 10 in FIG. 1, a low-profile multilayer ceramic capacitor can be provided without degradation of mountability during mounting. In addition, the durability of the multilayer ceramic capacitor can be improved by distributing the stress applied to the ridge line portions of the outer electrode 24.

### (4) Fourth Modification

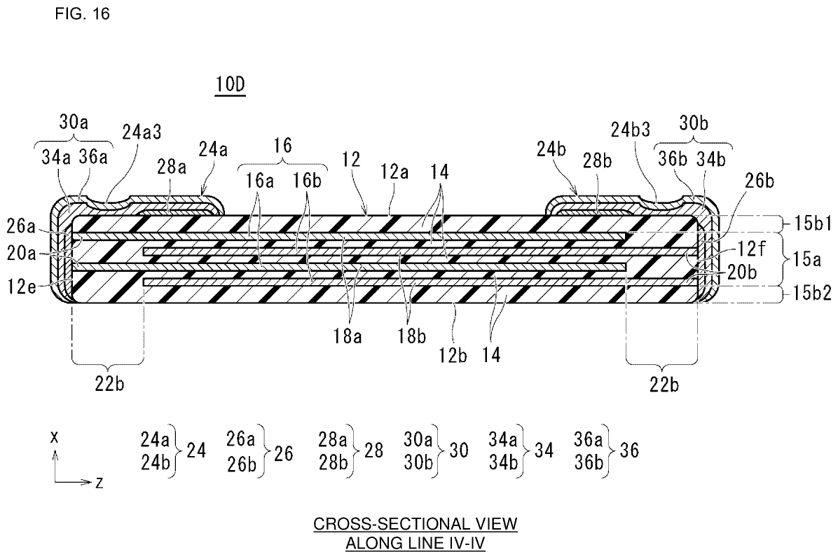

Next, an example of a multilayer ceramic capacitor 10D according to a fourth modification of the first example embodiment of the present invention will be described. FIG. 16 is a schematic cross-sectional view illustrating the example of the multilayer ceramic capacitor according to the fourth modification of the first example embodiment of the present invention. However, components that are the same as or correspond to those in FIGS. 1 to 11 are denoted by the same reference numerals and detailed descriptions are omitted.

In the multilayer ceramic capacitor 10D according to the fourth modification, as illustrated in FIG. 16, the first main surface electrode 28a and the second main surface electrode 28b are spaced apart from the first direct plating layer 26a and the second direct plating layer 26b, respectively, of the direct plating layer. In addition, the upper surface portion of the outer electrode 24, which is a portion of the outer electrode 24 that covers the first main surface 12a of the multilayer body 12, is provided as a concave surface with a curved shape that is recessed as viewed in the width direction y. The first main surface electrode 28a and the second main surface electrode 28b may be spaced apart from or may overlap the first direct plating layer 26a and the second direct plating layer 26b, respectively, of the direct plating layer.

Specifically, the first outer electrode 24a includes a portion of a surface parallel or substantially parallel to the first main surface 12a as a first concave surface 24a3. In addition, the second outer electrode 24b includes a portion of a surface parallel or substantially parallel to the first main surface 12a as a second concave surface 24b3.

In the multilayer ceramic capacitor 10D according to the fourth modification illustrated in FIG. 16, as in the multilayer ceramic capacitor 10 in FIG. 1, a low-profile multilayer ceramic capacitor can be provided without degradation of mountability during mounting. In addition, the accuracy of image recognition can be improved by generating diffuse reflection on the surface of the outer electrode 24 and reducing or preventing an occurrence of halation during the imaging of the multilayer ceramic capacitor.

### (5) Fifth Modification

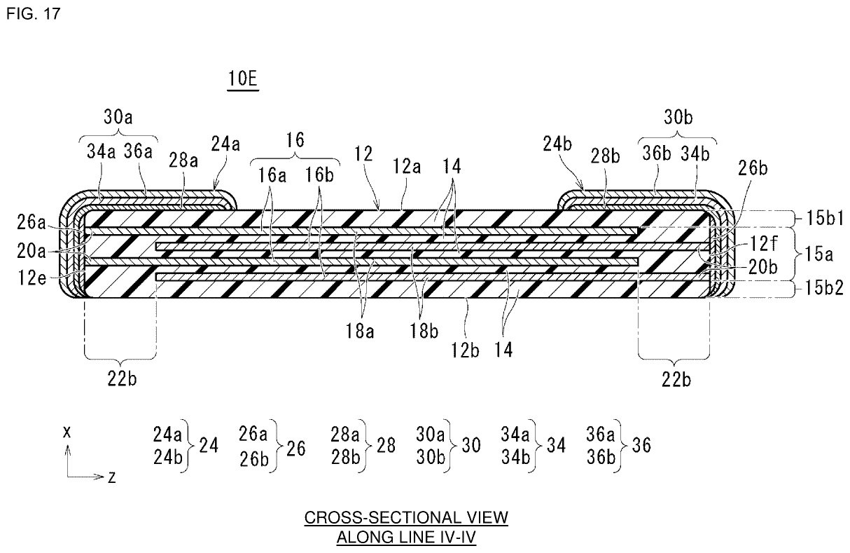

Next, an example of a multilayer ceramic capacitor 10E according to a fifth modification of the first example embodiment of the present invention will be described. FIG. 17 is a schematic cross-sectional view illustrating the example of the multilayer ceramic capacitor according to the fifth modification of the first example embodiment of the present invention. However, components that are the same as or correspond to those in FIGS. 1 to 11 are denoted by the same reference numerals and detailed descriptions are omitted.

The multilayer ceramic capacitor 10E according to the fifth modification is configured such that, as illustrated in FIG. 17, the first main surface electrode 28a and the second main surface electrode 28b wrap around the first end surface 12e and the second end surface 12f, respectively, of the multilayer body 12 and coat the first direct plating layer 26a and the second direct plating layer 26b, respectively, of the direct plating layer 26.

Specifically, the first main surface electrode 28a is provided by wrapping around the first end surface 12e from a surface parallel or substantially parallel to the first main surface 12a. In addition, the second main surface electrode 28b is provided by wrapping around the second end surface 12f from a surface parallel or substantially parallel to the first main surface 12a.

In the multilayer ceramic capacitor 10E according to the fifth modification illustrated in FIG. 17, as in the multilayer ceramic capacitor 10 in FIG. 1, a low-profile multilayer ceramic capacitor can be provided without degradation of mountability during mounting. In addition, moisture resistance can be improved by reducing or preventing moisture intrusion from the external environment into the multilayer body 12.

### (6) Sixth Modification

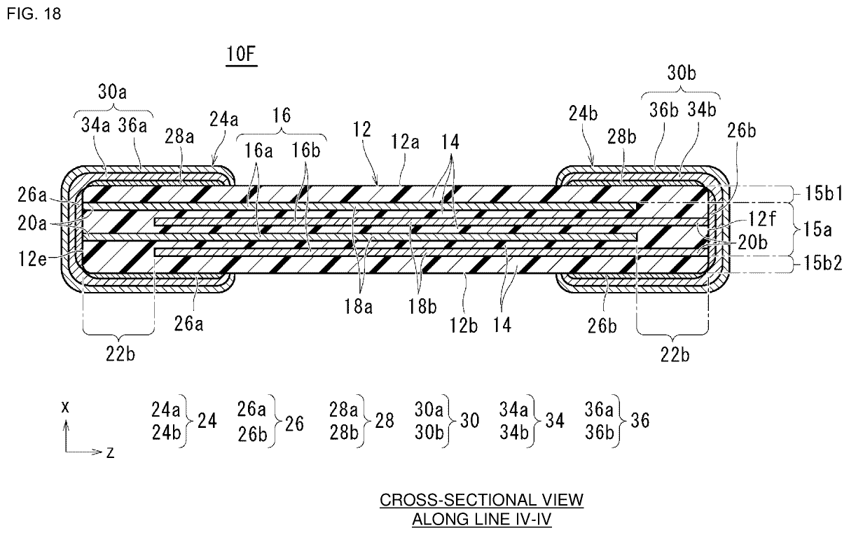

Next, an example of a multilayer ceramic capacitor 10F according to a sixth modification of the first example embodiment of the present invention will be described. FIG. 18 is a schematic cross-sectional view illustrating the example of the multilayer ceramic capacitor according to the sixth modification of the first example embodiment of the present invention. However, components that are the same as or correspond to those in FIGS. 1 to 11 are denoted by the same reference numerals and detailed descriptions are omitted.

The multilayer ceramic capacitor 10F according to the sixth modification includes, as illustrated in FIG. 18, the first main surface electrode 28a provided on a portion of the first main surface 12a and a portion of the second main surface 12b that are close to the first end surface 12e of the multilayer body 12. In addition, the second main surface electrode 28b is provided on a portion of the first main surface 12a and a portion of the second main surface 12b that are close to the second end surface 12f of the multilayer body 12.

In the multilayer ceramic capacitor 10F according to the sixth modification illustrated in FIG. 18, as in the multilayer ceramic capacitor 10 in FIG. 1, a low-profile multilayer ceramic capacitor can be provided without degradation of mountability during mounting, also in the multilayer ceramic capacitor in which the outer electrode 24 covers both of the first main surface 12a and the second main surface 12b of the multilayer body 12.

Some or all of the first to sixth modifications described above may be combined with each other.

### 2. Method of Manufacturing Multilayer Ceramic Capacitor

An example of a method of manufacturing a multilayer ceramic capacitor, which is an example of the multilayer ceramic capacitor according to the first example embodiment, will be described.

First, a dielectric sheet and a conductive paste for inner electrodes are prepared. The dielectric sheet and the conductive paste for inner electrode layers include a binder (for example, a known organic binder) and an organic solvent (for example, a known organic binder).

Next, a predetermined pattern of the conductive paste for inner electrodes is printed on the dielectric sheet by using, for example, screen printing or gravure printing to form an inner electrode pattern. Regarding dielectric sheets, dielectric sheets for outer layers not including inner electrode patterns are also manufactured.

A predetermined number of dielectric sheets for outer layers not including an inner electrode pattern are laminated together, a dielectric sheet including an inner electrode pattern corresponding to the first inner electrode layer 16a and a dielectric sheet including an inner electrode pattern corresponding to the second inner electrode layer 16b are alternately laminated together thereon, and a predetermined number of dielectric sheets for outer layers not including an inner electrode pattern are laminated together thereon to manufacture a laminated sheet.

In addition, the laminated sheet is pressed in the lamination direction by using a method, such as, for example, an isostatic press, to manufacture a laminated block.

Next, the laminated block is cut into a multilayer chip of a predetermined size. After that, for example, a wet barrel process may be performed to round corner portions and ridge line portions of the multilayer chip.

Next, the multilayer chip is burned to manufacture the multilayer body 12. The burning temperature, which depends on the material of the ceramic and the inner electrode layer 16, is, for example, preferably about 900° C. or more and about 1400° C. or less.

Next, the first direct plating layer 26a of the direct plating layer 26 is formed on the first end surface 12e of the multilayer body 12, and the second direct plating layer 26b of the direct plating layer 26 is formed on the second end surface 12f. Specifically, the direct plating layer 26 is, for example, Cu plating and is formed by electrolytic plating or electroless plating. At this time, a heat treatment is performed on the multilayer body 12 having been plated to remove the residual moisture that remains in the plating film and at the interface between the multilayer body 12 and the direct plating layer 26.

Next, the multilayer body 12 on which the direct plating layer 26 has been formed is arranged on a workbench, and the first main surface electrode 28a and the second main surface electrode 28b are formed on the first main surface 12a by using a sputtering method, for example.

Next, the first upper plating layer 34a of the upper plating layer 34 is formed so as to coat the first direct plating layer 26a disposed on the first end surface 12e of the multilayer body 12 and the first main surface electrode 28a disposed on a portion of the first main surface 12a of the multilayer body 12, and the first front plating layer 36a of the front plating layer 36 is formed so as to coat the first upper plating layer 34a. Similarly, the second upper plating layer 34b of the upper plating layer 34 is formed so as to coat the second direct plating layer 26b disposed on the second end surface 12f of the multilayer body 12 and the second main surface electrode 28b disposed on a portion of the first main surface 12a of the multilayer body 12, and the second front plating layer 36b of the front plating layer 36 is formed so as to coat the second upper: plating layer 34b. Specifically, for example, the upper plating layer 34 is Ni plating and the front plating layer 36 is Sn plating, and these plating layers are formed by electrolytic plating or electroless plating.

The process after the multilayer body 12 is obtained when the multilayer ceramic capacitor 10 according to the first modification illustrated in FIG. 12 is manufactured will be described below. That is, the first direct plating layer 26a and the second direct plating layer 26b of the direct plating layer 26 are formed on the first end surface 12e and the second end surface 12f of the multilayer body 12, respectively. Then, a heat treatment is performed on the multilayer body 12 in which the direct plating layer 26 has been formed to remove the residual moisture that remains in the plating film and at the interface between the multilayer body 12 and the direct plating layer 26. After that, the multilayer body 12 on which the direct plating layer 26 has been formed is arranged on a workbench, and the main surface electrode 28 is formed on the first main surface 12a by using a sputtering method, for example.

Next, the first lower plating layer 32a of the lower plating layer 32 is formed so as to coat the first direct plating layer 26a disposed on the first end surface 12e of the multilayer body 12 and the first main surface electrode 28a disposed on a portion of the first main surface 12a of the multilayer body 12. Similarly, the second lower plating layer 32b of the lower plating layer 32 is formed so as to coat the second direct plating layer 26b disposed on the second end surface 12f of the multilayer body 12 and the second main surface electrode 28b disposed on a portion of the first main surface 12a of the multilayer body 12. Specifically, for example, the lower plating layer 32 is Cu plating and is formed by electrolytic plating or electroless plating.

Then, the first upper plating layer 34a of the upper plating layer 34 is formed to cover the entire or substantially the entire first lower plating layer 32a, and the first front plating layer 36a of the front plating layer 36 is formed to cover the first upper plating layer 34a. Similarly, the second upper plating layer 34b of the upper plating layer 34 is formed to cover the entire or substantially the entire second lower plating layer 32b, and the second front plating layer 36b of the front plating layer 36 is formed to cover the second upper plating layer 34b. Specifically, for example, the upper plating layer 34 is Ni plating, the front plating layer 36 is Sn plating, and these plating layers are formed by electrolytic plating or electroless plating.

In this manner, the multilayer ceramic capacitor 10 according to the first example embodiment illustrated in FIG. 1 can be manufactured.

Inclined surfaces, such as the first inclined surface 24a1 of the first outer electrode 24a and the second inclined surface 24b1 of the second outer electrode 24b of the multilayer ceramic capacitor 10B according to the second modification illustrated in FIG. 14, can be formed by cutting target portions by using, for example, sandblasting. At this time, the shapes of the inclined surfaces can be adjusted by changing the distance and the angle with respect to the target portions as well as the strength of the sandblasting.

In addition, when curved surfaces, such as the first concave surface 24a2 of the first outer electrode 24a and the second concave surface 24b2 of the second outer electrode 24b of the multilayer ceramic capacitor 10C according to the third modification illustrated in FIG. 15 are formed or curved surfaces, such as the first concave surface 24a3 of the first outer electrode 24a and the second concave surface 24b3 of the second outer electrode 24b of the multilayer ceramic capacitor 10D according to the fourth modification illustrated in FIG. 16 are formed, these curved surfaces can be formed, as the inverted shape of the surface of the rod, by pushing a cutting metal rod against the target portions. At this time, the depth, the diameter, and the area of the curved surface can be adjusted by changing the diameter and the amount of insertion of the metal rod.

In the method of manufacturing the multilayer ceramic capacitor according to the present example embodiment, since the thickness (T-dimension) in the height direction x of the outer electrode 24 can be reduced while the outer electrode 24 is disposed on the first main surface 12a, a low-profile multilayer ceramic capacitor can be provided without degradation of mountability during mounting.

### B. Second Example Embodiment

### 1. Multilayer Ceramic Capacitor

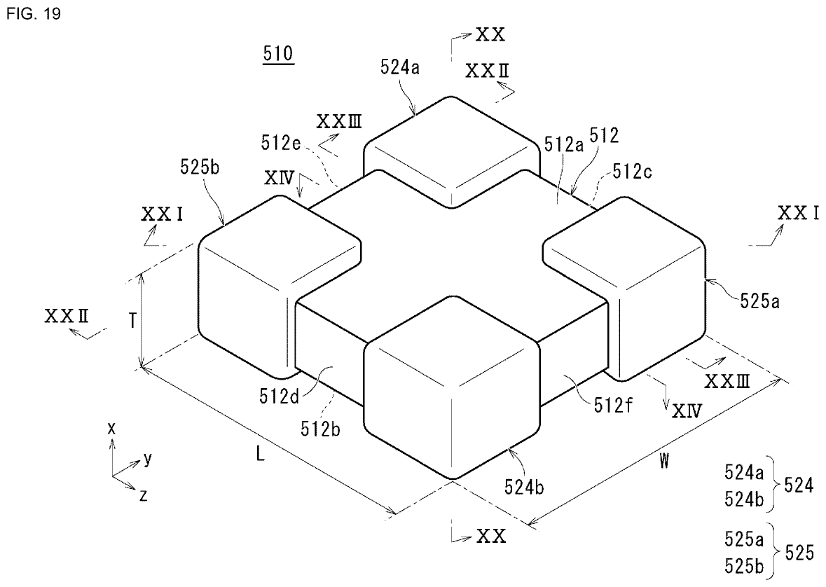

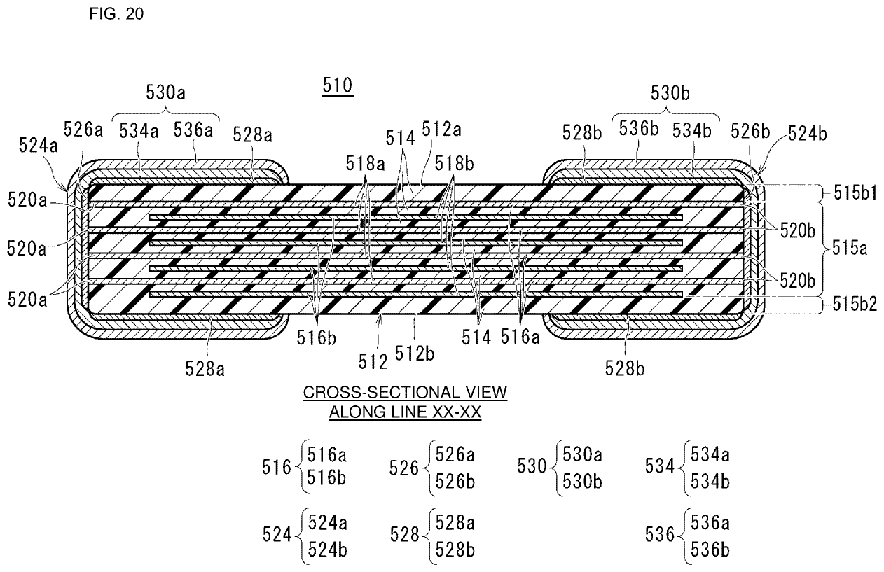

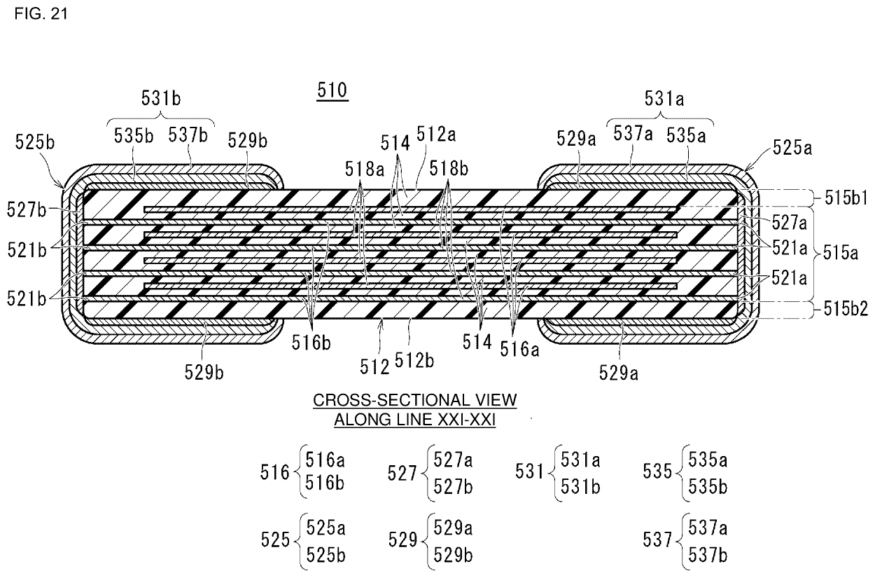

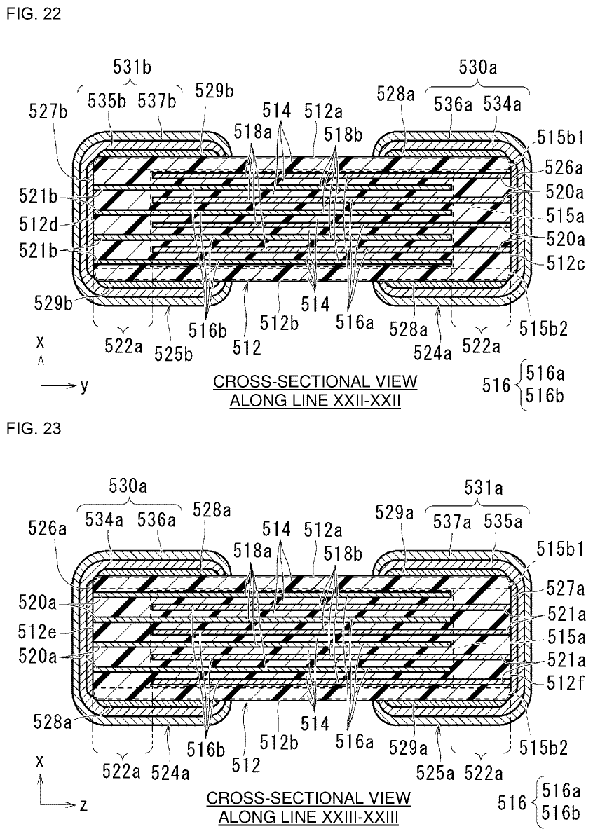

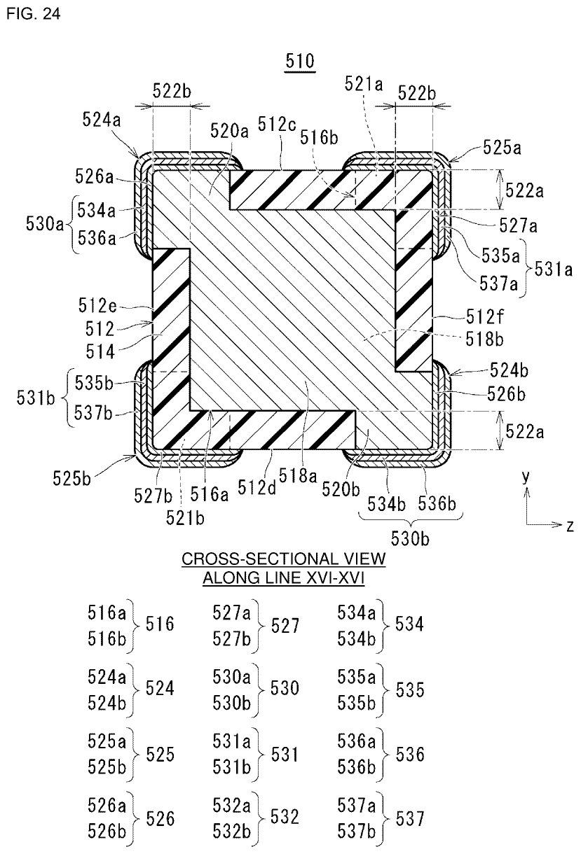

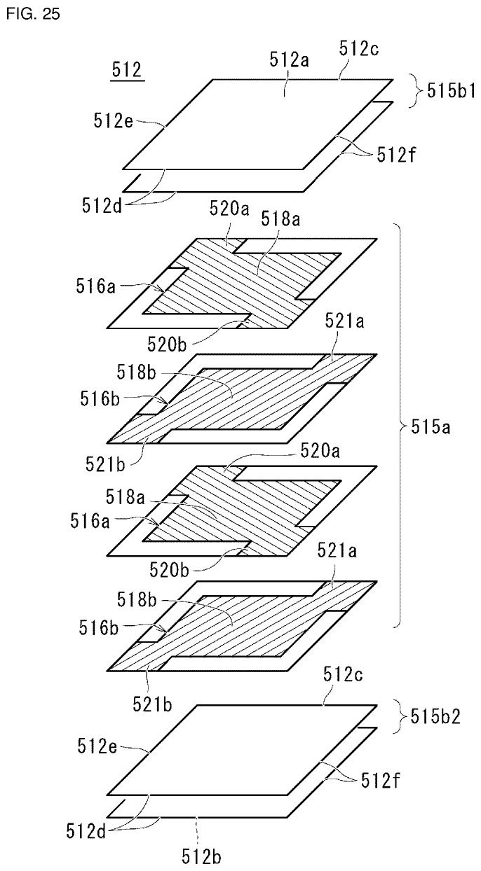

Next, an example of a multilayer ceramic capacitor 510 according to a second example embodiment of the present invention will be described. FIG. 19 is a perspective view illustrating the example of the multilayer ceramic capacitor according to the second example embodiment of the present invention. FIG. 20 is a schematic cross-sectional view taken along line XX-XX in FIG. 19. FIG. 21 is a schematic cross-sectional view taken along line XXI-XXI in FIG. 19. FIG. 22 is a schematic cross-sectional view taken along line XXII-XXII in FIG. 19. FIG. 23 is a schematic cross-sectional view taken along line XXIII-XXIII in FIG. 19. FIG. 24 is a schematic cross-sectional view taken along line XXIV-XXIV in FIG. 19. FIG. 25 is an exploded perspective view of the multilayer body illustrated in FIG. 19.

The multilayer ceramic capacitor 510 includes a multilayer body 512 and outer electrodes 524 and 525.

### Multilayer Body

The multilayer body 512 includes a plurality of dielectric layers 514 and a plurality of inner electrode layers 516. The multilayer body 512 includes a first main surface 512a and a second main surface 512b that face away from each other in the height direction x, a first side surface 512c and a second side surface 512d that face away from each other in the width direction y, and a third side surface 512e and a fourth side surface 512f that face away from each other in the length direction z orthogonal or substantially orthogonal to the height direction x and the width direction y. The first main surface 512a and the second main surface 512b extend in both the width direction y and the length direction z. The first side surface 512c and the second side surface 512d extend in both the height direction x and the length direction z. The third side surface 512e and the fourth side surface 512f extend in both the height direction x and the width direction y. Accordingly, the height direction x is the direction in which the first main surface 512a and the second main surface 512b are connected to each other, the width direction y is the direction in which the first side surface 512c and the second side surface 512d are connected to each other, and the length direction z is the direction in which the third side surface 512e and the fourth side surface 512f are connected to each other.

In addition, the corner portions and the ridge line portions of the multilayer body 512 are preferably rounded. Here, each of the corner portions refers to a portion at which three surfaces of the multilayer body 512 intersect each other, and each of the ridge line portions refers to a portion at which two surfaces of the multilayer body 512 intersect each other.

As illustrated in FIGS. 20 and 21, in the height direction x in which the first main surface 512a and the second main surface 512b are connected to each other, the multilayer body 512 includes an effective layer portion 515a in which the plurality of inner electrode layers 516 face each other, a first outer layer portion 515b1 including the plurality of dielectric layers 514 located between the inner electrode layer 516 closest to the first main surface 512a and the first main surface 512a, and a second outer layer portion 515b2 including the plurality of dielectric layers 514 located between the inner electrode layer 516 closest to the second main surface 512b and the second main surface 512b.

The first outer layer portion 515b1 is located close to the first main surface 512a of the multilayer body 512 and is an aggregation of the plurality of dielectric layers 514 located between the first main surface 512a and the inner electrode layer 516 closest to the first main surface 512a.

The second outer layer portion 515b2 is located close to the second main surface 512b of the multilayer body 512 and is an aggregation of the plurality of dielectric layers 514 located between the second main surface 512b and the inner electrode layer 516 closest to the second main surface 512b.

In addition, the region sandwiched between the first outer layer portion 515b1 and the second outer layer portion 515b2 is the effective layer portion 515a.

The material of the dielectric layer 514 may be, for example, a dielectric material. The dielectric material may be dielectric ceramic including, for example, BaTiO₃, CaTiO₃, SrTiO₃, or CaZrO₃ as main components. In addition, depending on the desired characteristics of the multilayer body, accessory components with a lower content than main components, such as, for example, Mn compounds, Fe compounds, Cr compounds, Co compounds, or Ni compounds, may be added.

The dielectric layer 514 may include, for example, a plurality of crystal grains that include a perovskite compound including BaTiO₃ as the fundamental structure.

The thinner the dielectric layers 514, the greater the capacitance of the capacitor, and accordingly, a crystal grain diameter of, for example, about 1 μm or less is preferred.

### Inner Electrode Layer

As illustrated in FIGS. 20 to 25, the inner electrode layer 516 includes a plurality of first inner electrode layers 516a and a plurality of second inner electrode layers 516b. The first inner electrode layer 516a and the second inner electrode layer 516b are alternately laminated with each other via the dielectric layer 514.

The first inner electrode layer 516a is disposed on the surface of the dielectric layer 514. In addition, the first inner electrode layers 516a include first opposed electrode portions 518a that face the first main surface 512a and the second main surface 512b and face the second inner electrode layers 516b and are laminated together in a direction in which the first main surface 512a and the second main surface 512b are connected to each other.

In addition, the second inner electrode layer 516b is disposed on a surface of a dielectric layer 514 that differs from the dielectric layer 514 on which the first inner electrode layer 516a is disposed. The second inner electrode layers 516b include second opposed electrode portions 518b that face the first main surface 512a and the second main surface 512b and are laminated together in the direction in which the first main surface 512a and the second main surface 512b are connected to each other.

As illustrated in FIGS. 20 to 25, the first inner electrode layers 516a are extended to the first side surface 512c and the third side surface 512e of the multilayer body 512 by a first extended electrode portions 520a and are extended to the second side surface 512d and the fourth side surface 512f of the multilayer body 512 by a second extended electrode portions 520b. The width of extension of the first extended electrode portions 520a to the first side surface 512c may be equal or substantially equal to the width of extension to the third side surface 512e, and the width of extension of the second extended electrode portions 520b to the second side surface 512d may be equal or substantially equal to the width of extension to the fourth side surface 512f.

That is, the first extended electrode portions 520a are extended to the third side surface 512e of the multilayer body 512, and the second extended electrode portions 520b are extended to the fourth side surface 512f of the multilayer body 512.

The second inner electrode layers 516b are extended to the first side surface 512c and the fourth side surface 512f of the multilayer body 512 by a third extended electrode portions 521a and are extended to the second side surface 512d and the third side surface 512e of the multilayer body 512 by a fourth extended electrode portions 521b. The width of extension of the third extended electrode portions 521a to the first side surface 512c may be equal or substantially equal to the width of extension to the fourth side surface 512f, and the width of extension of the fourth extended electrode portions 521b to the second side surface 512d may be equal or substantially equal to the width of extension to the third side surface 512e.

That is, the third extended electrode portions 521a are extended to the fourth side surface 512f of the multilayer body 512, and the fourth extended electrode portions 521b are extended to the third side surface 512e of the multilayer body 512.

In addition, when the multilayer ceramic capacitor 510 is viewed in the lamination direction, the straight line connecting the first extended electrode portion 520a and the second extended electrode portion 520b of the first inner electrode layer 516a preferably intersects the straight line connecting the third extended electrode portion 521a and the fourth extended electrode portion 521b of the second inner electrode layer 516b.

In addition, in the first side surface 512c, the second side surface 512d, the third side surface 512e, and the fourth side surface 512f of the multilayer body 512, the first extended electrode portions 520a of the first inner electrode layers 516a and the fourth extended electrode portions 521b of the second inner electrode layer 516b are preferably extended to positions that face each other, and the second extended electrode portions 520b of the first inner electrode layers 516a and the third extended electrode portions 521a of the second inner electrode layers 516b are preferably extended to positions that face each other.

In addition, as illustrated in FIG. 24, the multilayer body 512 includes side portions (W gaps) 522a of the multilayer body 512 provided between one ends of the first opposed electrode portions 518a in the width direction y and the first side surface 512c and between the other ends of the second opposed electrode portions 518b in the width direction y and the second side surface 512d.

In addition, as illustrated in FIG. 24, the multilayer body 512 includes side portions (L gaps) 522b of the multilayer body 512 provided between one ends of the first opposed electrode portions 518a in the length direction z and the third side surface 512e and between the other ends of the second opposed electrode portions 518b in the length direction z and the fourth side surface 512f.

The inner electrode layer 516 may be made of an appropriate conductive material, such as, for example, a metal including Ni, Cu, Ag, Pd, or Au, or an alloy including at least one of these metals, such as an Ag—Pd alloy, but the present invention is not limited to this example.

### Outer Electrode

As illustrated in FIGS. 19 to 24, the outer electrodes 524 and 525 are disposed on the multilayer body 512.

The outer electrode 524 includes a direct plating layer 526, a main surface electrode 528, and a plating layer 530 coating the direct plating layer 526 and the main surface electrode 528.

The outer electrode 525 includes a direct plating layer 527, a main surface electrode 529, and a plating layer 531 coating the direct plating layer 527 and the main surface electrode 529.

The outer electrode 524 includes a first outer electrode 524a and a second outer electrode 524b.

The first outer electrode 524a is disposed so as to cover the first extended electrode portion 520a on the first side surface 512c and the third side surface 512e and is disposed so as to cover a portion of the first main surface 512a. The first outer electrode 524a is electrically connected to the first extended electrode portion 520a of the first inner electrode layer 516a.

The second outer electrode 524b is disposed so as to cover the second extended electrode portion 520b on the second side surface 512d and the fourth side surface 512f and is disposed so as to cover a portion of the first main surface 512a. The second outer electrode 524b is electrically connected to the second extended electrode portion 520b of the first inner electrode layer 516a.

The outer electrode 525 includes a third outer electrode 525a and a fourth outer electrode 525b.

The third outer electrode 525a is disposed so as to cover the third extended electrode portion 521a on the first side surface 512c and the fourth side surface 512f and is disposed so as to cover a portion of the first main surface 512a. The third outer electrode 525a is electrically connected to the third extended electrode portion 521a of the second inner electrode layer 516b.

The fourth outer electrode 525b is disposed so as to cover the fourth extended electrode portion 521b on the second side surface 512d and the third side surface 512e and is disposed so as to cover a portion of the first main surface 512a. The fourth outer electrode 525b is electrically connected to the fourth extended electrode portion 521b of the second inner electrode layer 516b.

The first opposed electrode portion 518a of the first inner electrode layer 516a faces the second opposed electrode portion 518b of the second inner electrode layer 516b via the dielectric layer 514 in the multilayer body 512, and accordingly, electrostatic capacitance is generated. Therefore, electrostatic capacitance can be obtained between the first outer electrode 524a and the second outer electrode 524b to which the first inner electrode layer 516a is connected and the third outer electrode 525a and the fourth outer electrode 525b to which the second inner electrode layer 516b is connected, and accordingly, the characteristics of a capacitor are provided.

### Direct Plating Layer

The direct plating layer 526 includes a first direct plating layer 526a and a second direct plating layer 526b.

The direct plating layer 527 includes a third direct plating layer 527a and a fourth direct plating layer 527b.

The first direct plating layer 526a of the direct plating layer 526 is disposed so as to coat a portion of the first side surface 512c and a portion of the third side surface 512e of the multilayer body 512 as well as the ridge line portion therebetween. The first direct plating layer 526a is electrically connected directly to the first extended electrode portion 520a of the first inner electrode layer 516a.

The second direct plating layer 526b of the direct plating layer 526 is disposed so as to coat a portion of the second side surface 512d and a portion of the fourth side surface 512f of the multilayer body 512 as well as the ridge line portion therebetween. The second direct plating layer 526b is electrically connected directly to the second extended electrode portion 520b of the first inner electrode layer 516a.

The third direct plating layer 527a of the direct plating layer 527 is disposed so as to coat a portion of the first side surface 512c and a portion of the fourth side surface 512f of the multilayer body 512 as well as the ridge line portion therebetween. The third direct plating layer 527a is electrically connected directly to the third extended electrode portion 521a of the second inner electrode layer 516b.

The fourth direct plating layer 527b of the direct plating layer 527 is disposed so as to coat a portion of the third side surface 512e and a portion of the second side surface 512d of the multilayer body 512 as well as the ridge line portion therebetween. The fourth direct plating layer 527b is electrically connected directly to the fourth extended electrode portion 521b of the second inner electrode layer 516b.

The direct plating layer 526 and the direct plating layer 527 are not particularly limited as long as the direct plating layers include at least one metal, such as, for example, Cu, Ni, Ag, Pd, Ag—Pd alloy, or Au as a main metallic component. When the first inner electrode layer 516a and the second inner electrode layer 516b include, for example, Ni, Cu plating having good bondability with Ni is preferably adopted as the direct plating layer 526 and the direct plating layer 527.

The direct plating layer 526 and the direct plating layer 527 are formed such that plating grows from the inner electrode layer 516 and covers the first side surface 512c, the second side surface 512d, the third side surface 512e, and the fourth side surface 512f.

The thickness of each of the direct plating layers 526 and the thickness of each of the direct plating layers 527 are, for example, preferably about 2.0 μm or more and about 10.0 μm or less.

### Main Surface Electrode

The main surface electrode 528 includes a first main surface electrode 528a and a second main surface electrode 528b.

The main surface electrode 529 includes a third main surface electrode 529a and a fourth main surface electrode 529b.

The first main surface electrodes 528a are disposed so as to cover a portion of the first main surface 512a and a portion of the second main surface 512b of the multilayer body 512 close to the first side surface 512c and the third side surface 512e without covering the first side surface 512c and the third side surface 512e of the multilayer body 512.

The second main surface electrodes 528b are disposed so as to cover a portion of the first main surface 512a and a portion of the second main surface 512b of the multilayer body 512 close to the second side surface 512d and the fourth side surface 512f without covering the second side surface 512d and the fourth side surface 512f.

The third main surface electrodes 529a are disposed so as to cover a portion of the first main surface 512a and a portion of the second main surface 512b of the multilayer body 512 close to the first side surface 512c and the fourth side surface 512f without covering the first side surface 512c and the fourth side surface 512f.

The fourth main surface electrodes 529b are disposed so as to cover a portion of the first main surface 512a and a portion of the second main surface 512b of the multilayer body 512 close to the third side surface 512e and the second side surface 512d without covering the third side surface 512e and the second side surface 512d.

The first main surface electrode 528a and the fourth main surface electrode 529b are preferably formed by, for example, deposition of metal particles formed by a thin film formation method, such as a sputtering method. As a result, since the thicknesses of the first main surface electrode 528a to the fourth main surface electrode 529b in the direction in which the first main surface 512a and the second main surface 512b of the multilayer body 512 are connected to each other can be, for example, about 1 μm or less and the dimension of the multilayer ceramic capacitor 510 in the height direction x can be sufficiently small, low profile can be achieved.

When the main surface electrodes are formed by the deposition of metal particles as in the first example embodiment, the dimensions of the first main surface electrode 528a to the fourth main surface electrode 529b in the height direction x can be measured, for example, by using a method that performs thickness conversion from the concentration of a predetermined element by using the calibration curve method of the corresponding metal that uses a fluorescent X-ray device. In other cases, a cross-section of a component by FIB can be observed by using a scanning electron microscope, and the thickness can be measured from the actual observation image.

In addition, when the first main surface electrode 528a to the fourth main surface electrode 529b are formed by a thin film formation method, these main surface electrodes can include a metal, such as Cu, Cr, Au, Pt, Ag, Sn, Ti, or Ni.

The first main surface electrode 528a to the fourth main surface electrode 529b can be configured in consideration of their respective functions. The main surface electrodes can be made of NiCr or the like in consideration of, for example, the degree of close contact with the multilayer body 512.

In addition, when the first main surface electrode 528a to the fourth main surface electrode 529b include the same main component as the dielectric layer 514, the degree of close contact can be further improved by simultaneously burning the multilayer body 512 and the first to fourth main surface electrodes. In this case, for example, Ni, Cu, and the like are preferable as the metal components, but the metal components can be changed as appropriate according to the metal components of the inner electrode layer 516.

### Plating Layer

The plating layer 530 includes a first plating layer 530a and a second plating layer 530b.

The first plating layer 530a is disposed so as to coat the first main surface electrode 528a and the first side surface 512c and the third side surface 512e of the multilayer body 512.

The second plating layer 530b is disposed so as to coat the second main surface electrode 528b and the second side surface 512d and the fourth side surface 512f of the multilayer body 512.

The plating layer 531 includes a third plating layer 531a and a fourth plating layer 531b.

The third plating layer 531a is disposed so as to coat the third main surface electrode 529a and the first side surface 512c and the fourth side surface 512f of the multilayer body 512.

The fourth plating layer 531b is disposed so as to coat the fourth main surface electrode 529b and the second side surface 512d and the third side surface 512e of the multilayer body 512.

Each of the plating layer 530 and the plating layer 531 includes a plurality of layers. That is, the plating layer 530 includes an upper plating layer 534 and a front plating layer 536. The plating layer 531 includes an upper plating layer 535 and a front plating layer 537.

The upper plating layer 534 includes a first upper plating layer 534a included in the first plating layer 530a and a second upper plating layer 534b included in the second plating layer 530b. The front plating layer 536 includes a first front plating layer 536a included in the first plating layer 530a and a second front plating layer 536b included in the second plating layer 530b.

The upper plating layer 535 includes a third upper plating layer 535a included in the third plating layer 531a and a fourth upper plating layer 535b included in the fourth plating layer 531b. The front plating layer 537 includes a third front plating layer 537a included in the third plating layer 531a and a fourth front plating layer 537b included in the fourth plating layer 531b.

The first upper plating layer 534a of the upper plating layer 534 is disposed so as to coat the first direct plating layer 526a of the direct plating layer 526 and the first main surface electrode 528a.

The second upper plating layer 534b of the upper plating layer 534 is disposed so as to coat the second direct plating layer 526b of the direct plating layer 526 and the second main surface electrode 528b.

The third upper plating layer 535a of the upper plating layer 535 is disposed so as to coat the third direct plating layer 527a of the direct plating layer 527 and the third main surface electrode 529a.

The fourth upper plating layer 535b of the upper plating layer 535 is disposed so as to coat the fourth direct plating layer 527b of the direct plating layer 527 and the fourth main surface electrode 529b.

The upper plating layer 534 and the upper plating layer 535 are, for example, preferably Ni plating to prevent elution to solder.

The first front plating layer 536a of the front plating layer 536 is disposed so as to coat the first upper plating layer 534a of the upper plating layer 534.

The second front plating layer 536b of the front plating layer 536 is disposed so as to coat the second upper plating layer 534b of the upper plating layer 534.

The third front plating layer 537a of the front plating layer 537 is disposed so as to coat the third upper plating layer 535a of the upper plating layer 535.

The fourth front plating layer 537b of the front plating layer 537 is disposed so as to coat the fourth upper plating layer 535b of the upper plating layer 535.

The front plating layer 536 and the front plating layer 537 are, for example, preferably Sn plating having good bondability with the solder used to mount the multilayer ceramic capacitor 510. In addition, the front plating layer 536 and the front plating layer 537 may also be Cu plating, for example. In this case, it is possible to improve the bondability with the vias formed when the multilayer ceramic capacitor 510 is embedded in the mounting substrate.

The plating layer 530 may include only the front plating layer 536. In this case, the first front plating layer 536a of the front plating layer 536 is disposed so as to coat the first direct plating layer 526a and the first main surface electrode 528a, and the second front plating layer 536b of the front plating layer 536 is disposed so as to coat the second direct plating layer 526b and the second main surface electrode 528b. Similarly, the plating layer 531 may include only the front plating layer 537. In this case, the third front plating layer 537a of the front plating layer 537 is disposed so as to coat the third direct plating layer 527a and the third main surface electrode 529a, and the fourth front plating layer 537b of the front plating layer 537 is disposed so as to coat the fourth direct plating layer 527b and the third main surface electrode 529b.

The ratios of metal per unit volume of the plating layer 530 and the plating layer 531 are, for example, preferably about 99 vol % or more.

The thickness of each of the plating layer 530 and the plating layer 531 is, for example, preferably about 1.0 μm or more and about 10.0 μm or less.

The dimension in the length direction z of the multilayer ceramic capacitor 510 including the multilayer body 512, the outer electrode 524, and the outer electrode 525 is defined as an L-dimension, the dimension in the height direction x of the multilayer ceramic capacitor 510 including the multilayer body 512, the outer electrode 524, and the outer electrode 525 is defined as a T-dimension, and the dimension in the width direction y of the multilayer ceramic capacitor 510 including the multilayer body 512, the outer electrode 524, and the outer electrode 525 is defined as a W-dimension.

The dimensions of the multilayer ceramic capacitor 510 are, for example, preferably as follows: the L-dimension in the length direction z is about 0.1 mm or more and about 6.0 mm or less, the T-dimension in the height direction x is about 40 μm or more and about 300 μm or less, and the W-dimension in the width direction y is about 0.1 mm or more and about 6.0 mm or less. The dimension of the multilayer ceramic capacitor 510 is, for example, preferably about 7/10≤L/W≤about 10/7. Since the multilayer body 512 having the dimensions is tetragonal or substantially tetragonal, the degree of freedom in mounting is improved.

In the multilayer ceramic capacitor 510 illustrated in FIG. 19, the first main surface electrode 528a is disposed on the first main surface 512a and the second main surface 512b of the multilayer body 512, and the second main surface electrode 528b is disposed on the first main surface 512a and the second main surface 512b of the multilayer body 512 in the outer electrode 524.

In addition, in the multilayer ceramic capacitor 510, the third main surface electrode 529a is disposed on the first main surface 512a and the second main surface 512b of the multilayer body 512, and the fourth main surface electrode 529b is disposed on the first main surface 512a and the second main surface 512b of the multilayer body 512 in the outer electrode 525.

In addition, in the multilayer ceramic capacitor 510, the electrical connection between the outer electrode 524 and the inner electrode layer 516 is made through the direct plating layer 526 and the direct plating layer 527 disposed on the first side surface 512c to the fourth side surface 512f, not through the first main surface electrode 528a to the fourth main surface electrode 529b. In addition, the direct plating layer 526 and the direct plating layer 527 are not formed on the first main surface 512a and the second main surface 512b.

As a result, since the thicknesses (T-dimensions) in the height direction x of the outer electrode 524 and the outer electrode 525 can be reduced while the outer electrode 524 and the outer electrode 525 are disposed on the first main surface 512a and the second main surface 512b in the multilayer ceramic capacitor 510 illustrated in FIG. 19, a low-profile multilayer ceramic capacitor can be provided without degradation of mountability during mounting.

In addition, since the outer electrode 524 and the outer electrode 525 are disposed on all side surfaces of the multilayer body 512, which are the first side surface 512c, the second side surface 512d, the third side surface 512e, and the fourth side surface 512f in the multilayer ceramic capacitor 510 illustrated in FIG. 19, moisture intrusion from the external environment can be suppressed.

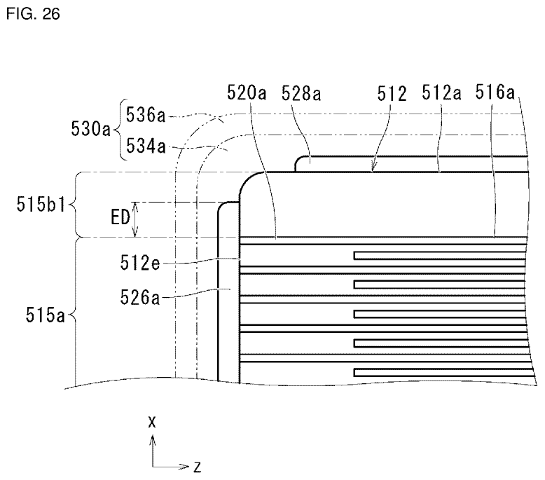

Here, in the first direct plating layer 526a illustrated in FIG. 26 as an example, a distance ED between the first direct plating layer 526a and a portion, exposed to the third side surface 512e, of the first extended electrode portion 520a of the first inner electrode layer 516a that is the inner electrode layer 516 closest to the first main surface 512a of the multilayer body 512 is, for example, preferably about 1 μm or more and about 20 μm or less along the shape of the multilayer body 512. More preferably, the distance ED is smaller than the thickness of the outer layer portion (the first outer layer portion 515b1 in FIG. 26) at the center of the multilayer body 512 in the length direction z and the width direction y. As a result, the dimension in the lamination direction x can be reduced. The same applies to the side close to the second main surface 512b.

In addition, although not illustrated, the distance ED between the third direct plating layer 527a and a portion, exposed to the fourth side surface 512f, of the third extended electrode portion 521a of the first inner electrode layer 516a that is the inner electrode layer 516 closest to the first main surface 512a of the multilayer body 512 is, for example, preferably about 1 μm or more and about 20 μm or less along the shape of the multilayer body 512. More preferably, the distance ED is smaller than the thickness of the outer layer portion at the center of the multilayer body 512 in the length direction z and the width direction y. As a result, the dimension in the lamination direction x can be reduced. The same applies to the side close to the second main surface 512b.

In the range described above, it is possible to reduce the amount of overlap with the first main surface 512a at the upper end of the first direct plating layer 526a while reducing or preventing moisture intrusion into the first side surface 512c and the third side surface 512e of the multilayer body 512. That is, when the dimension in the height direction x of the first outer layer portion 515b1 close to the first main surface 512a is about 20 μm or more, for example, the first direct plating layer 526a does not substantially overlap the first main surface 512a. Similarly, it is possible to reduce the amount of overlap with the first main surface 512a at the upper end of the third direct plating layer 527a while reducing or preventing moisture intrusion into the first side surface 512c and the fourth side surface 512f of the multilayer body 512. That is, when the dimension in the height direction x of the first outer layer portion 515b1 close to the first main surface 512a is about 20 μm or more, for example, the third direct plating layer 527a can have a structure that does not substantially overlap the first main surface 512a.

On the other hand, when the upper end of the first direct plating layer 526a extends to the first main surface 512a of the multilayer body 512 and overlaps the first main surface electrode 528a, the first main surface electrode 528a may cover a portion of the first direct plating layer 526a from end portions toward the central side of the multilayer body 512 to about 100% or less of the first direct plating layer 526a. That is, the first main surface electrode 528a may completely coat the first direct plating layer 526a in the length direction z and the width direction y as viewed in the height direction x. Similarly, when the upper end of the third direct plating layer 527a reaches the first main surface 512a of the multilayer body 512 and overlaps the third main surface electrode 529a, the third main surface electrode 529a may cover a portion of the third direct plating layer 527a from end portions toward the central side of the multilayer body 512 to about 100% or less of the third direct plating layer 527a. That is, the third main surface electrode 529a may completely coat the third direct plating layer 527a in the length direction z and the width direction y as viewed in the height direction x.

In addition, although not illustrated, the upper end of the first direct plating layer 526a of the direct plating layer 526 may extend onto the first main surface 512a across the ridge line portion provided by the first main surface 512a and the first side surface 512c of the multilayer body 512 and the ridge line portion provided by the first main surface 512a and the third side surface 512e of the multilayer body 512 and define the lower layer of the first main surface electrode 528a. Similarly, the upper end of the second direct plating layer 526b of the direct plating layer 526 may also extend onto the first main surface 512a across the ridge line portion provided by the first main surface 512a and the second side surface 512d of the multilayer body 512, the first main surface 512a, and the fourth side surface 512f and define the lower layer of the second main surface electrode 528b. As a result, moisture intrusion from the external environment can be effectively reduced or prevented. The present invention is not limited to this example, and the upper end of the first direct plating layer 526a of the direct plating layer 526 may extend onto the second main surface 512b across the ridge line portion provided by the second main surface 512b and the first side surface 512c of the multilayer body 512 and the ridge line portion provided by the second main surface 512b and the third side surface 512e of the multilayer body 512. Similarly, the upper end of the second direct plating layer 526b of the direct plating layer 526 may also extend onto the second main surface 512b across the ridge line portion provided by the second main surface 512b and the second side surface 512d of the multilayer body 512 and the ridge line portion provided by the second main surface 512b and the fourth side surface 512f of the multilayer body 512.

In addition, although not illustrated, the upper end of the third direct plating layer 527a of the direct plating layer 527 may extend onto the first main surface 512a across the ridge line portion provided by the first main surface 512a and the first side surface 512c of the multilayer body 512 and the ridge line portion provided by the first main surface 512a and the fourth side surface 512f of the multilayer body 512 and define the lower layer of the third main surface electrode 529a. Similarly, the upper end of the fourth direct plating layer 527b of the direct plating layer 527 may also extend onto the first main surface 512a across the ridge line portion provided by the first main surface 512a and the second side surface 512d of the multilayer body 512, the first main surface 512a, and the third side surface 512e and define the lower layer of the fourth main surface electrode 529b. As a result, moisture intrusion from the external environment can be effectively reduced or prevented. The present invention is not limited to this example, and the upper end of the third direct plating layer 527a of the direct plating layer 527 may extend onto the second main surface 512b across the ridge line portion provided by the second main surface 512b and the first side surface 512c of the multilayer body 512 and the ridge line portion provided by the second main surface 512b and the fourth side surface 512f of the multilayer body 512. Similarly, the upper end of the fourth direct plating layer 527b of the direct plating layer 527 may also extend onto the second main surface 512b across the ridge line portion provided by the second main surface 512b and the second side surface 512d of the multilayer body 512 and the ridge line portion provided by the second main surface 512b and the third side surface 512e of the multilayer body 512.

### (1) First Modification

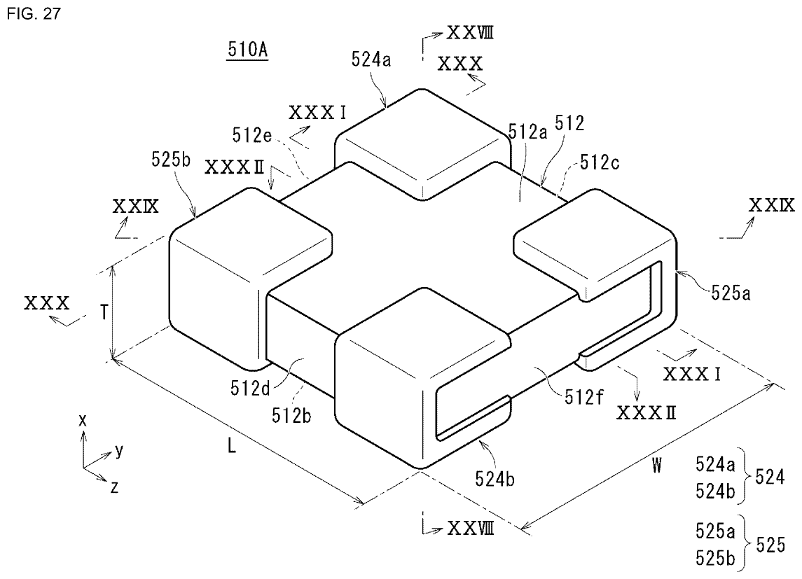

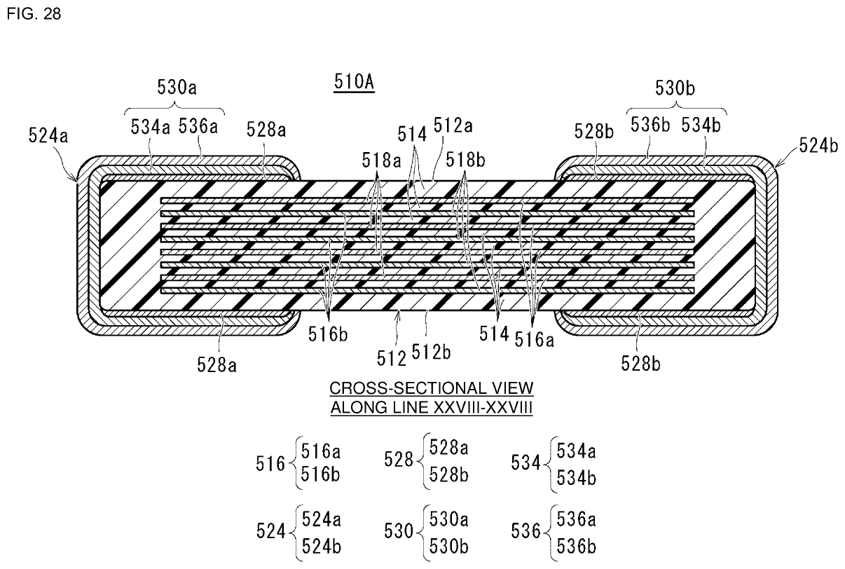

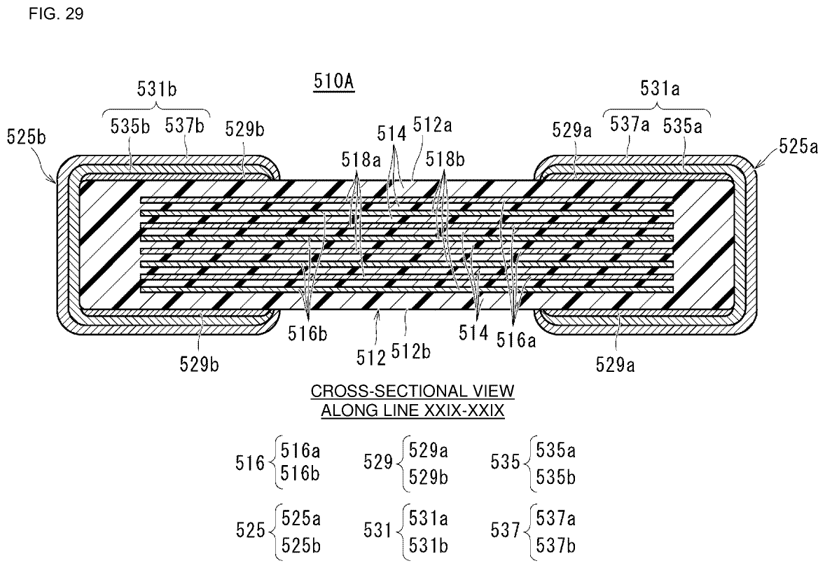

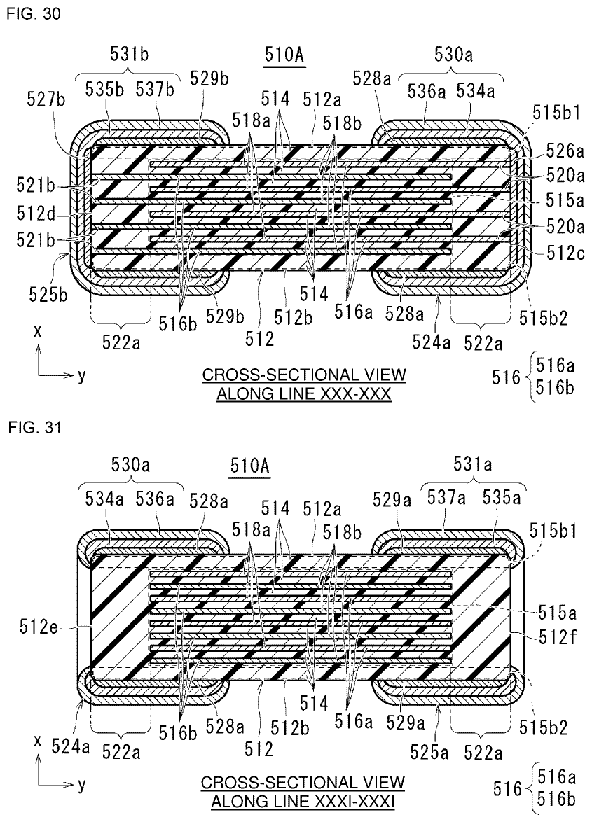

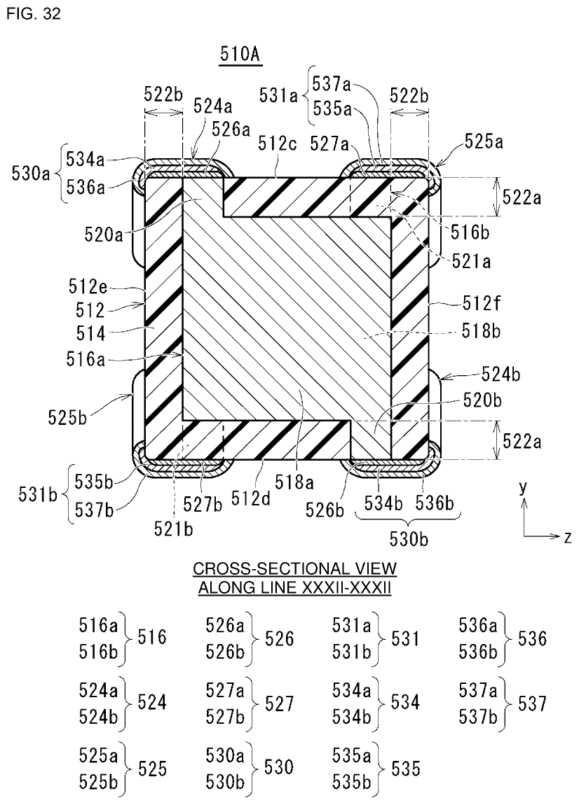

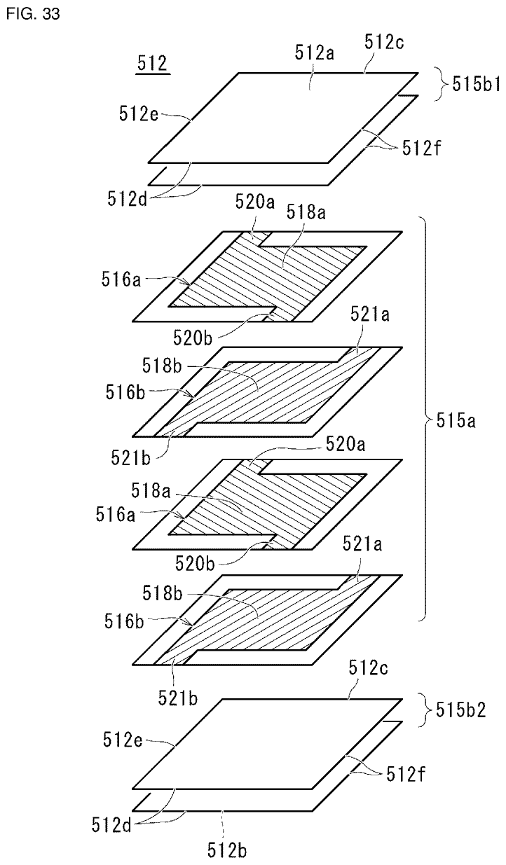

Next, an example of a multilayer ceramic capacitor 510A according to a first modification of the second example embodiment of the present invention will be described. FIG. 27 is a perspective view illustrating an example of a multilayer ceramic capacitor according to a first modification of the second example embodiment of the present invention. FIG. 28 is a schematic cross-sectional view taken along line XXVIII-XXVIII in FIG. 27. FIG. 29 is a schematic cross-sectional view taken along line XXIX-XXIX in FIG. 27. FIG. 30 is a schematic cross-sectional view taken along line XXX-XXX in FIG. 27. FIG. 31 is a schematic cross-sectional view taken along line XXXI-XXXI in FIG. 27. FIG. 32 is a schematic cross-sectional view taken along line XXXII-XXXII in FIG. 27. FIG. 33 is an exploded perspective view of the multilayer body illustrated in FIG. 27. However, components that are the same or substantially the same as or correspond to those in FIGS. 19 to 25 are denoted by the same reference numerals and detailed descriptions are omitted.

In the multilayer body 512 of the multilayer ceramic capacitor 510A according to the first modification, as illustrated in FIG. 33, each of the plurality of first inner electrode layers 516a of the inner electrode layer 516 is extended only to the first side surface 512c of the multilayer body 512 by the first extended electrode portion 520a and is extended only to the second side surface 512d of the multilayer body 512 by the second extended electrode portion 520b.

In addition, each of the plurality of second inner electrode layers 516b of the inner electrode layer 516 is extended only to the first side surface 512c of the multilayer body 512 by the third extended electrode portion 521a and is extended only to the second side surface 512d of the multilayer body 512 by the fourth extended electrode portion 521b.

In the multilayer ceramic capacitor 510A according to the first modification, the first direct plating layer 526a of the direct plating layer 526 is disposed so as to coat a portion of the first side surface 512c and a portion of the third side surface 512e of the multilayer body 512 and the ridge line portion therebetween. The first direct plating layer 526a is electrically connected directly to the first extended electrode portion 520a of the first inner electrode layer 516a.

The second direct plating layer 526b of the direct plating layer 526 is disposed so as to coat a portion of the second side surface 512d and a portion of the fourth side surface 512f of the multilayer body 512 and the ridge line portion therebetween. The second direct plating layer 526b is electrically connected directly to the second extended electrode portion 520b of the first inner electrode layer 516a.

The third direct plating layer 527a of the direct plating layer 527 is disposed so as to coat a portion of the first side surface 512c and a portion of the fourth side surface 512f of the multilayer body 512 and the ridge line portion therebetween. The third direct plating layer 527a is electrically connected directly to the third extended electrode portion 521a of the second inner electrode layer 516b.

The fourth direct plating layer 527b of the direct plating layer 527 is disposed so as to coat a portion of the second side surface 512d and a portion of the second side surface 512d of the multilayer body 512 and the ridge line portion therebetween. The fourth direct plating layer 527b is electrically connected directly to the fourth extended electrode portion 521b of the second inner electrode layer 516b.

Accordingly, the direct plating layer 526 and the direct plating layer 527 are not disposed on the third side surface 512e and the fourth side surface 512f of the multilayer body 512 to which neither the first inner electrode layer 516a nor the second inner electrode layer 516b is extended.

In the multilayer ceramic capacitor 510A according to the first modification illustrated in FIG. 27 as described above, as in the multilayer ceramic capacitor 510 in FIG. 19, a low-profile multilayer ceramic capacitor can be provided without degradation of mountability during mounting, also in the multilayer ceramic capacitor in which the inner electrode layer 516 is extended to the first side surface 512c and the second side surface 512d of the multilayer body 512.

### (2) Second Modification

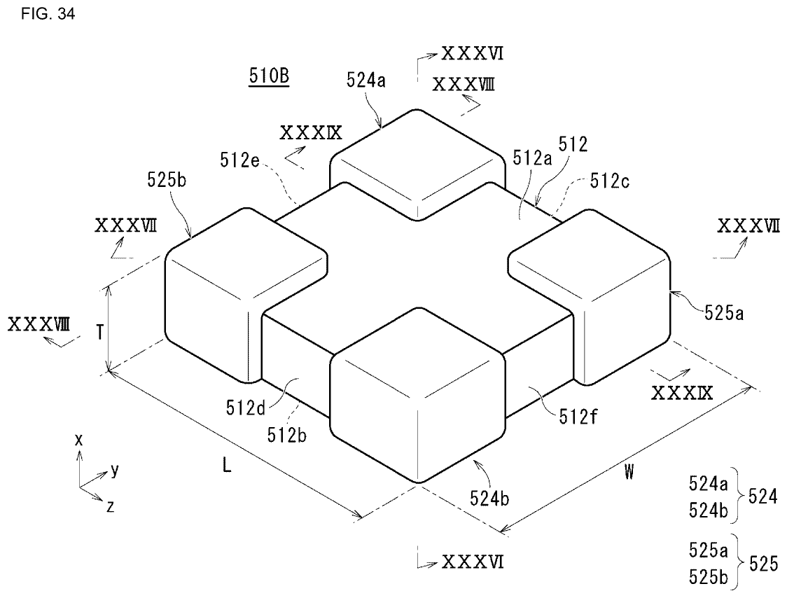

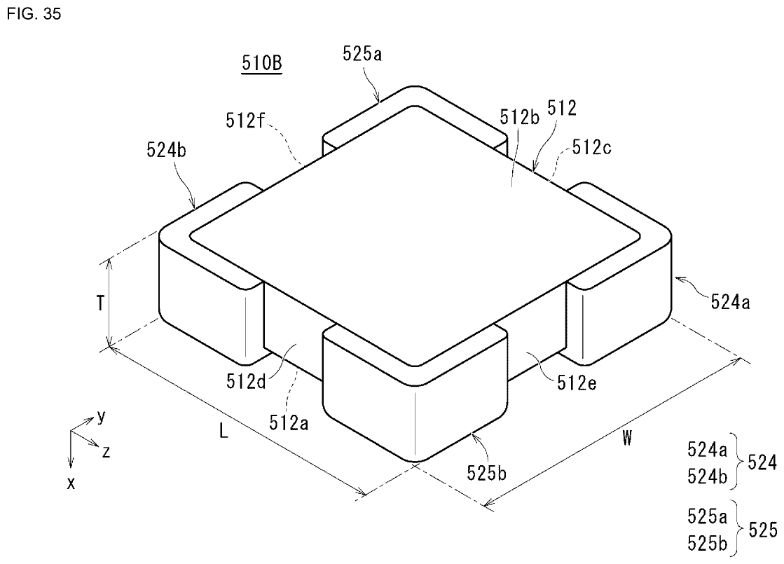

Next, an example of a multilayer ceramic capacitor 510B according to a second modification of the second example embodiment of the present invention will be described. FIG. 34 is a perspective view illustrating an example of the multilayer ceramic capacitor according to the second modification of the second example embodiment of the present invention as viewed from diagonally above. FIG. 35 is a perspective view illustrating the example of the multilayer ceramic capacitor according to the second modification of the second example embodiment of the present invention as viewed from diagonally below.

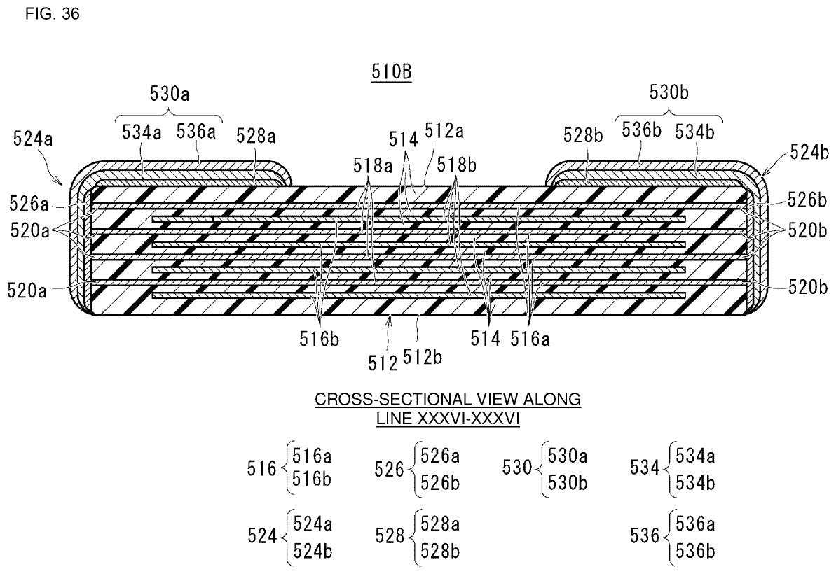

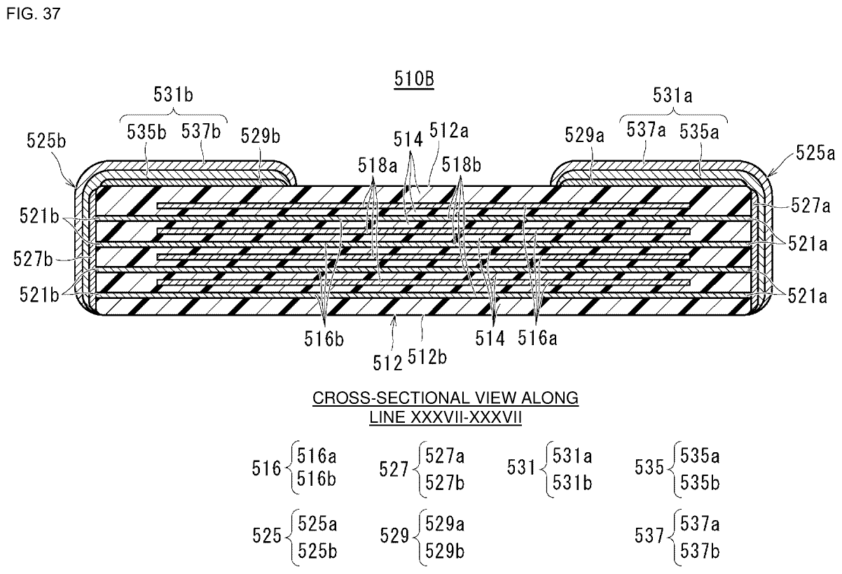

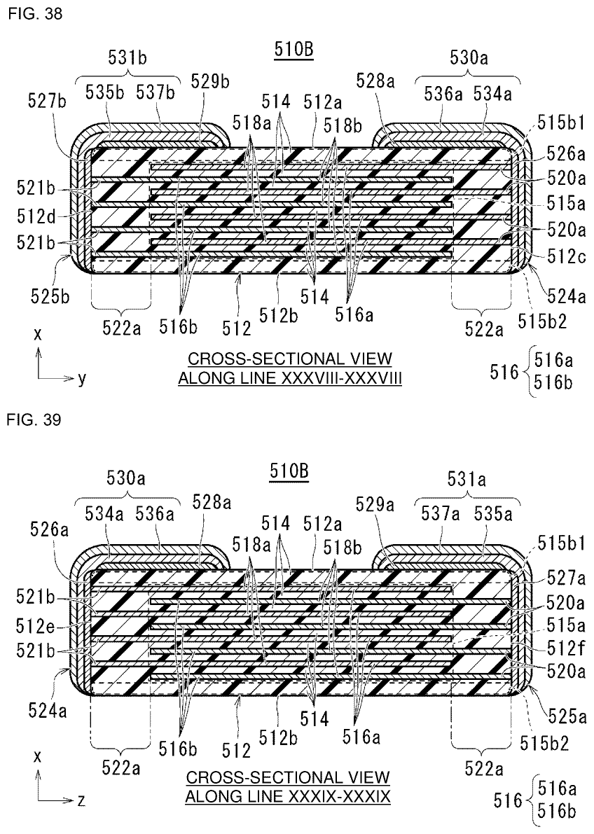

FIG. 36 is a schematic cross-sectional view taken along line XXXVI-XXXVI in FIG. 34. FIG. 37 is a schematic cross-sectional view taken along line XXXVII-XXXVII in FIG. 34. FIG. 38 is a schematic cross-sectional view taken along line XXXVIII-XXXVIII in FIG. 34. FIG. 39 is a schematic cross-sectional view taken along line XXXIX-XXXIX in FIG. 34. However, components that are the same as or correspond to those in FIGS. 19 to 25 and FIGS. 27 to 33 are denoted by the same reference numerals and detailed descriptions are omitted.

In the multilayer ceramic capacitor 510B according to the second modification, the multilayer body 512 has the same or substantially the same structure as the multilayer body 512 according to the second example embodiment of the present invention illustrated in FIG. 27. That is, in the multilayer body 512, the first inner electrode layer 516a of the inner electrode layer 516 is extended to the first side surface 512c and the third side surface 512e of the multilayer body 512 by the first extended electrode portion 520a and is extended to the second side surface 512d and the fourth side surface 512f of the multilayer body 512 by the second extended electrode portion 520b.

The second inner electrode layer 516b of the inner electrode layer 516 is extended to the first side surface 512c and the fourth side surface 512f of the multilayer body 512 by the third extended electrode portion 521a and is extended to the second side surface 512d and the third side surface 512e of the multilayer body 512 by the fourth extended electrode portion 521b.

In the multilayer ceramic capacitor 510B according to the second modification, the outer electrode 524 and the outer electrode 525 are disposed so as to cover the first main surface 512a of the multilayer body 512 without covering the second main surface 512b.

Specifically, the first outer electrode 524a of the outer electrode 524 is disposed so as to cover the first extended electrode portion 520a on the first side surface 512c and the third side surface 512e and is disposed so as to cover a portion of the first main surface 512a without covering the second main surface 512b.

The second outer electrode 524b of the outer electrode 524 is disposed so as to cover the second extended electrode portion 520b on the second side surface 512d and the fourth side surface 512f and is disposed so as to cover a portion of the first main surface 512a without covering the second main surface 512b.

The third outer electrode 525a of the outer electrode 525 is disposed so as to cover the third extended electrode portion 521a on the first side surface 512c and the fourth side surface 512f and is disposed so as to cover a portion of the first main surface 512a without covering the second main surface 512b.

The fourth outer electrode 525b of the outer electrode 525 is disposed so as to cover the fourth extended electrode portion 521b on the second side surface 512d and the third side surface 512e and is disposed so as to cover a portion of the first main surface 512a without covering the second main surface 512b.

### Direct Plating Layer

The direct plating layer 526 includes the first direct plating layer 526a and the second direct plating layer 526b.

The direct plating layer 527 includes the third direct plating layer 527a and the fourth direct plating layer 527b.

The first direct plating layer 526a of the direct plating layer 526 is disposed so as to coat a portion of the first side surface 512c and a portion of the third side surface 512e of the multilayer body 512 as well as the ridge line portion therebetween. The first direct plating layer 526a is directly connected to the first extended electrode portion 520a of the first inner electrode layer 516a.

The second direct plating layer 526b of the direct plating layer 526 is disposed so as to coat a portion of the second side surface 512d and a portion of the fourth side surface 512f of the multilayer body 512 as well as the ridge line portion therebetween. The second direct plating layer 526b is directly connected to the second extended electrode portion 520b of the first inner electrode layer 516a.

The third direct plating layer 527a of the direct plating layer 527 is disposed so as to coat a portion of the first side surface 512c and a portion of the fourth side surface 512f of the multilayer body 512 as well as the ridge line portion therebetween. The third direct plating layer 527a is directly connected to the third extended electrode portion 521a of the second inner electrode layer 516b.

The fourth direct plating layer 527b of the direct plating layer 527 is disposed so as to coat a portion of the third side surface 512e and a portion of the second side surface 512d of the multilayer body 512 as well as the ridge line portion therebetween. The fourth direct plating layer 527b is directly connected to the fourth extended electrode portion 521b of the second inner electrode layer 516b.

### Main Surface Electrode

The main surface electrode 528 includes the first main surface electrode 528a and the second main surface electrode 528b.

The main surface electrode 529 includes the third main surface electrode 529a and the fourth main surface electrode 529b.

The first main surface electrode 528a is disposed so as to cover a portion of the first main surface 512a of the multilayer body 512 close to the first side surface 512c and the third side surface 512e without covering the first side surface 512c and the third side surface 512e of the multilayer body 12.

The second main surface electrode 528b is disposed so as to cover a portion of the first main surface 512a of the multilayer body 512 close to the second side surface 512d and the fourth side surface 512f without covering the second side surface 512d and the fourth side surface 512f.

The third main surface electrode 529a is disposed so as to cover a portion of the first main surface 512a of the multilayer body 512 close to the first side surface 512c and the fourth side surface 512f without covering the first side surface 512c and the fourth side surface 512f.

The fourth main surface electrode 529b is disposed so as to cover a portion of the first main surface 512a of the multilayer body 512 close to the third side surface 512e and the second side surface 512d without covering the third side surface 512e and the second side surface 512d.

### Plating Layer

The plating layer 530 includes the first plating layer 530a and the second plating layer 530b.

The first plating layer 530a is disposed so as to coat the first main surface electrode 528a as well as the first side surface 512c and the third side surface 512e of the multilayer body 512.

The second plating layer 530b is disposed so as to coat the second main surface electrode 528b as well as the second side surface 512d and the fourth side surface 512f of the multilayer body 512.

The plating layer 531 includes the third plating layer 531a and the fourth plating layer 531b.

The third plating layer 531a is disposed so as to coat the third main surface electrode 529a as well as the first side surface 512c and the fourth side surface 512f of the multilayer body 512.

The fourth plating layer 531b is disposed so as to coat the fourth main surface electrode 529b as well as the second side surface 512d and the third side surface 512e of the multilayer body 512.

In the multilayer ceramic capacitor 510B according to the second modification illustrated in FIGS. 34 to 39 as described above, as in the multilayer ceramic capacitor 510 in FIG. 19, a low-profile multilayer ceramic capacitor can be provided without degradation of mountability during mounting, also in the multilayer ceramic capacitor in which the outer electrode 524 and the outer electrode 525 are disposed so as to cover only the first main surface 512a of the multilayer body 512 without covering the second main surface 512b.

The multilayer body 512 of the multilayer ceramic capacitor 510B according to the second modification may be replaced with the multilayer body 512 of the multilayer ceramic capacitor 510A according to the first modification in which the inner electrode layer 516 is extended only to the first side surface 512c and the fourth side surface 512f.

In addition, the multilayer ceramic capacitor 510B according to the second modification may have a structure in which the outer electrode 524 and the outer electrode 525 cover a portion of the second main surface 512b without covering the first main surface 512a.

In addition, the multilayer ceramic capacitor 510 according to the second example embodiment of the present invention may also be combined with all or some of the first modification and the second modification described above. Furthermore, the multilayer ceramic capacitor 510 may also be combined with all or some of the first to sixth modifications of the multilayer ceramic capacitor 10 according to the first example embodiment or other modifications illustrated in the drawings.

### 2. Method of Manufacturing Multilayer Ceramic Capacitor

A method of manufacturing a multilayer ceramic capacitor, which is an example of the multilayer ceramic capacitor according to the second example embodiment, will be described.

First, a dielectric sheet and a conductive paste for inner electrodes are prepared. The dielectric sheet and the conductive paste for inner electrode layers include a binder (for example, a known organic binder) and an organic solvent (for example, a known organic binder).

Next, a predetermined pattern of the conductive paste for inner electrodes is printed on the dielectric sheet by using, for example, screen printing or gravure printing to form an inner electrode pattern. Specifically, the conductive paste layer is formed by applying a paste made of a conductive material onto the dielectric sheet by using a method, such as the printing method described above, for example. The paste made of a conductive material is created by, for example, adding an organic binder and an organic solvent to metal powder. Regarding dielectric sheets, dielectric sheets for outer layers not including inner electrode patterns are also manufactured.

As a result, the dielectric sheet including the inner electrode pattern corresponding to the first inner electrode layer 516a and the dielectric sheet including the inner electrode pattern corresponding to the second inner electrode layer 516b are prepared.

More specifically, a screen plate on which the first inner electrode layer 516a is printed is prepared separately from a screen plate on which the second inner electrode layer 516b is printed, and a printing machine capable of separately printing the two types of screen plates can be used to print the inner electrode layers.

A laminated sheet is created by using these dielectric sheets on which the inner electrode patterns are provided. That is, a portion that becomes the first outer layer portion 515b1 close to the first main surface 512a is formed by laminating a predetermined number of dielectric sheets for outer layers that do not include inner electrode patterns. The dielectric sheet including an inner electrode pattern corresponding to the first inner electrode layer 516a and the dielectric sheet including an inner electrode pattern corresponding to the second inner electrode layer 516b are alternately laminated together thereon to form a portion that becomes the effective layer portion 515a, and a predetermined number of dielectric sheets for outer layers that do not include inner electrode patterns are laminated together thereon to form a portion that becomes the second outer layer portion 515b2. As a result, the laminated sheet is manufactured.

In addition, the laminated sheet is pressed in the lamination direction by using a method, for example, such as an isostatic press, to manufacture a laminated block.

Next, the laminated block is cut into a multilayer chip of a predetermined size. After that, for example, a wet barrel process is performed to round the corner portions and the ridge line portions of the multilayer chip.

Next, a multilayer chip is burned to manufacture the multilayer body 512. The burning temperature, which depends on the material of the ceramic and the inner electrode, is, for example, preferably about 900° C. or more and about 1400° C. or less.

Next, the direct plating layer 526 and the direct plating layer 527 are formed at the same time. That is, a first direct plating layer 526a of the direct plating layer 526 is formed on a portion of the first side surface 512c and a portion of the third side surface 512e of the multilayer body 512 as well as the ridge line portion therebetween.

The second direct plating layer 526b of the direct plating layer 526 is formed on a portion of the second side surface 512d and a portion of the fourth side surface 512f of the multilayer body 512 as well as the ridge line portion therebetween.

The third direct plating layer 527a of the direct plating layer 527 is formed on a portion of the first side surface 512c and a portion of the fourth side surface 512f of the multilayer body 512 as well as the ridge line portion therebetween.

The fourth direct plating layer 527b of the direct plating layer 527 is formed on a portion of the third side surface 512e and a portion of the second side surface 512d of the multilayer body 512 as well as the ridge line portion therebetween.

Specifically, the direct plating layer 526 and the direct plating layer 527 are, for example, Cu plating and are formed by electrolytic plating or electroless plating. At this time, a heat treatment is performed on the multilayer body 512 having been plated to remove the residual moisture that remains in the plating film and at the interfaces between the multilayer body 512 and the direct plating layers 526 and 527.

Next, the multilayer body 512 on which the direct plating layer 526 and the direct plating layer 527 have been formed is arranged on a workbench, and the main surface electrode 528 and the main surface electrode 529 are formed on the first main surface 512a and the second main surface 512b by using a sputtering method, for example.

Next, the upper plating layer 534, the upper plating layer 535, the front plating layer 536, and the front plating layer 537 are sequentially formed.

That is, the first upper plating layer 534a of the upper plating layer 534 is formed so as to cover the first direct plating layer 526a disposed on a portion of the first side surface 512c and a portion of the third side surface 512e of the multilayer body 512 and the first main surface electrode 528a disposed on a portion of the first main surface 512a and a portion of the second main surface 512b of the multilayer body 512, and the first front plating layer 536a of the front plating layer 536 is formed so as to cover the first upper plating layer 534a.

The second upper plating layer 534b of the upper plating layer 534 is formed so as to cover the second direct plating layer 526b disposed on a portion of the second side surface 512d and a portion of the fourth side surface 512f of the multilayer body 512 and the second main surface electrode 528b disposed on a portion of the first main surface 512a and a portion of the second main surface 512b of the multilayer body 512, and the second front plating layer 536b of the front plating layer 536 is formed so as to cover the second upper plating layer 534b.

The third upper plating layer 535a of the upper plating layer 535 is formed so as to cover the third direct plating layer 527a disposed on a portion of the first side surface 512c and a portion of the fourth side surface 512f of the multilayer body 512 and the third main surface electrode 529a disposed on a portion of the first main surface 512a and a portion of the second main surface 512b of the multilayer body 512, and the third front plating layer 537a of the front plating layer 537 is formed so as to cover the third upper plating layer 535a.

The fourth upper plating layer 535b of the upper plating layer 535 is formed so as to cover the fourth direct plating layer 527b disposed on a portion of the second side surface 512d and a portion of the third side surface 512e of the multilayer body 512 and the fourth main surface electrode 529b disposed on a portion of the first main surface 512a and a portion of the second main surface 512b of the multilayer body 512, and the fourth front plating layer 537b of the front plating layer 537 is formed so as to cover the fourth upper plating layer 535b.

Specifically, for example, the upper plating layer 534 and the upper plating layer 535 are Ni plating, the front plating layer 536 and the front plating layer 537 are Sn plating, and these plating layers are formed by electrolytic plating or electroless plating.

In this manner, the multilayer ceramic capacitor 510 according to the second example embodiment illustrated in FIG. 19 can be manufactured. When the multilayer ceramic capacitor 510A according to the first modification illustrated in FIG. 27 and the multilayer ceramic capacitor 510B according to the second modification illustrated in FIGS. 34 and 35 are manufactured, the shapes of corresponding portions at individual positions should be varied as appropriate in individual processes.

In the method of manufacturing the multilayer ceramic capacitor according to the present example embodiment, since the thicknesses (T-dimensions) in the height direction x of the outer electrode 524 and the outer electrode 525 formed on the first main surface 512a and the second main surface 512b can be reduced, a low-profile multilayer ceramic capacitor can be provided without degradation of mountability during mounting.

### C. Third Example Embodiment

### 1. Multilayer Ceramic Capacitor

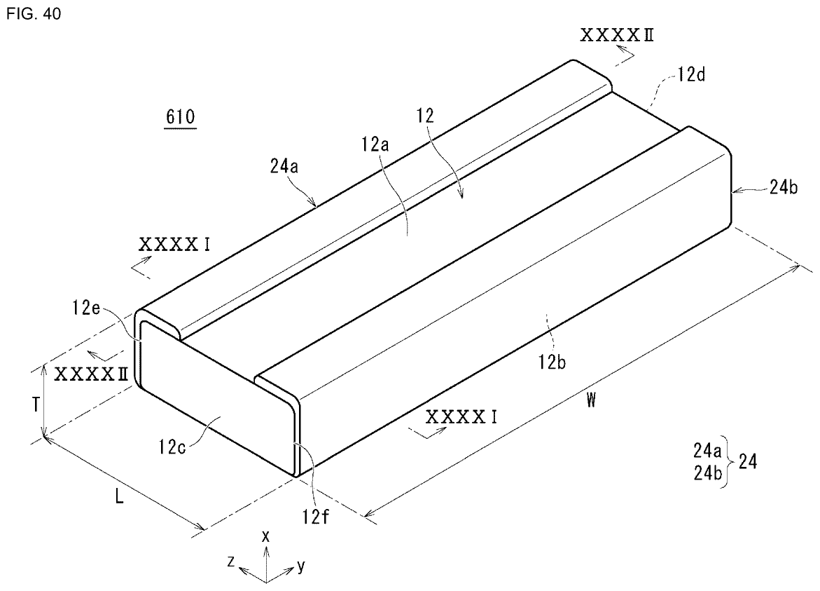

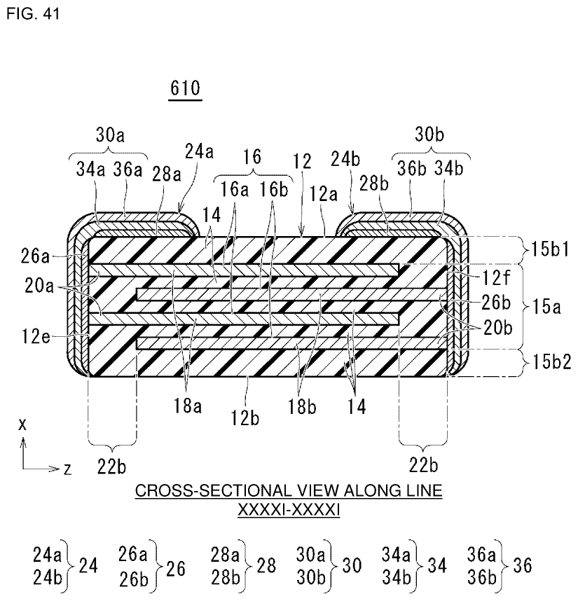

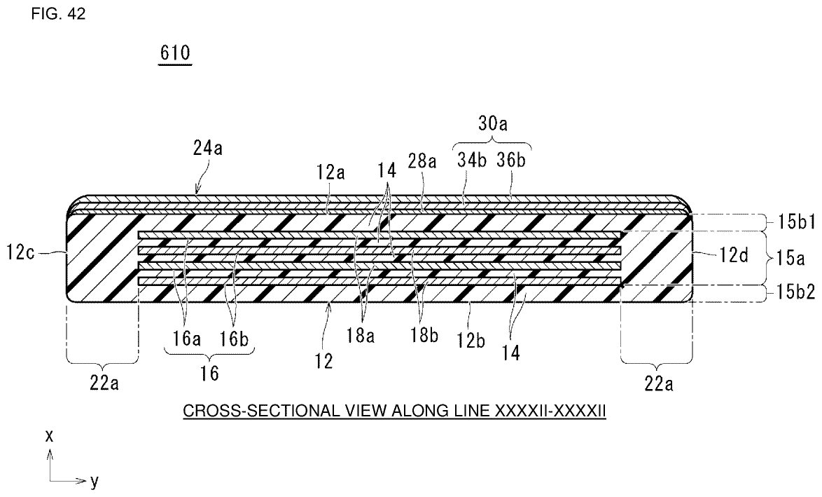

Next, an example of a multilayer ceramic capacitor 610 according to a third example embodiment of the present invention will be described. FIG. 40 is a perspective view illustrating the example of the multilayer ceramic capacitor according to the third example embodiment of the present invention. FIG. 41 is a schematic cross-sectional view taken along line XXXXI-XXXXI in FIG. 40. FIG. 42 is a schematic cross-sectional view taken along line XXXXII-XXXXII in FIG. 40. However, components that are the same as or correspond to those of the multilayer ceramic capacitor 10 according to the first example embodiment illustrated in FIGS. 1 to 11 are denoted by the same reference numerals and detailed descriptions are omitted.

The multilayer ceramic capacitor 610 according to the third example embodiment of the present invention includes the multilayer body 12 and the outer electrode 24 that have structures the same as or similar to those of the multilayer ceramic capacitor 10 according to the first example embodiment. However, the magnitude relationship between the L-dimension and the W-dimension in the multilayer ceramic capacitor 610 is opposite to that in the multilayer ceramic capacitor 10 according to the first example embodiment, and the W-dimension is larger than the L-dimension.

Specifically, the dimensions of the multilayer ceramic capacitor 610 are, for example, preferably as follows: the L-dimension in the length direction z is about 0.1 mm or more and about 2.5 mm or less, the T-dimension in the height direction x is about 0.04 mm or more and about 2.5 mm or less, and the W-dimension in the width direction y is about 0.2 mm or more and about 3.2 mm or less.

More preferably, the T-dimension of the multilayer ceramic capacitor 610 is about 100 μm or less, for example. Even more preferably, the T-dimension of the multilayer ceramic capacitor 610 is about 60 μm or less, for example.

The multilayer ceramic capacitor 610 having the structure described above in FIG. 40 has the same or substantially the same advantageous effects as the multilayer ceramic capacitor 10 according to the first example embodiment.

Also in the multilayer ceramic capacitor according to the third example embodiment of the present invention, the outer electrode 24 of the multilayer ceramic capacitor 610 preferably includes all or some of first to sixth modifications similar to the first to sixth modifications of the outer electrode 24 of the multilayer ceramic capacitor 10 according to the first example embodiment or preferably includes a combination of all or some of the first to sixth modifications.

### 2. Method of Manufacturing Multilayer Ceramic Capacitor

A method of manufacturing a multilayer ceramic capacitor, which is an example of the multilayer ceramic capacitor according to the third example embodiment, will be described.

The method of manufacturing the multilayer ceramic capacitor according to the third example embodiment is the same or substantially the same as that of the multilayer ceramic capacitor according to the first example embodiment. However, the multilayer ceramic capacitor according to the third example embodiment is created such that the L-dimension and the W-dimension of the multilayer ceramic capacitor 10 according to the first example embodiment are interchanged with each other.

In this manner, the multilayer ceramic capacitor 610 according to the third example embodiment illustrated in FIG. 40 can be manufactured.

In the method of manufacturing the multilayer ceramic capacitor according to the present example embodiment as described above, since the thickness (T-dimension) in the height direction x of the outer electrode 24 formed on the first main surface 12a can be reduced, a lower-profile multilayer ceramic capacitor can be provided.

Example embodiments of the present invention have been disclosed as described above, but the present invention is not limited to the example embodiments.

That is, various changes can be made to mechanisms, shapes, materials, quantities, positions, or arrangements, and the like of the example embodiments and the modifications described above without departing from the technical idea and the scope of the present invention, and these changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated dielectric layers, a first main surface and a second main surface facing away from each other in a lamination direction of the plurality of laminated dielectric layers, a first side surface and a second side surface facing away from each other in a width direction orthogonal or substantially orthogonal to the lamination direction, and a first end surface and a second end surface facing away from each other in a length direction orthogonal or substantially orthogonal to the lamination direction and the width direction;
a first outer electrode on the first main surface and the first end surface of the multilayer body; and
a second outer electrode on the first main surface and the second end surface of the multilayer body; wherein
the first outer electrode includes:
a first direct plating layer covering the first end surface;
a first main surface electrode covering at least a portion of the first main surface;
a first upper plating layer; and
a first front plating layer; and
the second outer electrode includes:
a second direct plating layer covering the second end surface;
a second main surface electrode covering at least a portion of the first main surface;
a second upper plating layer; and
a second front plating layer.

2. The multilayer ceramic capacitor according to claim 1, wherein a dimension in the width direction is greater than a dimension in the length direction.

3. The multilayer ceramic capacitor according to claim 1, wherein about 7/10≤L/W≤about 10/7 is satisfied, where W denotes a dimension of the multilayer ceramic capacitor in the width direction and L denotes a dimension of the multilayer ceramic capacitor in the width direction.

4. The multilayer ceramic capacitor according to claim 1, wherein the first outer electrode includes a portion corresponding to a ridge line portion provided by the first main surface and the first end surface, as a first concave surface extending from the first main surface toward the first end surface.

5. The multilayer ceramic capacitor according to claim 1, wherein the first outer electrode includes a portion corresponding to a ridge line portion provided by the first main surface and the first end surface, as a first inclined surface that has a depression angle from the first main surface toward the first end surface.

6. The multilayer ceramic capacitor according to claim 1, wherein the first outer electrode includes a portion of a surface parallel or substantially parallel to the first main surface as a first concave surface.

7. The multilayer ceramic capacitor according to claim 1, wherein the first main surface electrode includes the same main component as the dielectric layer.

8. The multilayer ceramic capacitor according to claim 1, wherein the first main surface electrode covers at least a portion of the first direct plating layer.

9. The multilayer ceramic capacitor according to claim 2, wherein the first outer electrode includes a portion corresponding to a ridge line portion provided by the first main surface and the first end surface, as a first concave surface extending from the first main surface toward the first end surface.

10. The multilayer ceramic capacitor according to claim 2, wherein the first outer electrode includes a portion corresponding to a ridge line portion provided by the first main surface and the first end surface, as a first inclined surface that has a depression angle from the first main surface toward the first end surface.

11. The multilayer ceramic capacitor according to claim 2, wherein the first outer electrode includes a portion of a surface parallel or substantially parallel to the first main surface as a first concave surface.

12. The multilayer ceramic capacitor according to claim 2, wherein the first main surface electrode includes the same main component as the dielectric layer.

13. The multilayer ceramic capacitor according to claim 2, wherein the first main surface electrode covers at least a portion of the first direct plating layer.

14. The multilayer ceramic capacitor according to claim 3, wherein the first outer electrode includes a portion corresponding to a ridge line portion provided by the first main surface and the first end surface, as a first concave surface extending from the first main surface toward the first end surface.

15. The multilayer ceramic capacitor according to claim 3, wherein the first outer electrode includes a portion corresponding to a ridge line portion provided by the first main surface and the first end surface, as a first inclined surface that has a depression angle from the first main surface toward the first end surface.

16. The multilayer ceramic capacitor according to claim 3, wherein the first outer electrode includes a portion of a surface parallel or substantially parallel to the first main surface as a first concave surface.

17. The multilayer ceramic capacitor according to claim 3,
wherein the first main surface electrode includes the same main component as the dielectric layer.

18. The multilayer ceramic capacitor according to claim 3, wherein the first main surface electrode covers at least a portion of the first direct plating layer.

19. The multilayer ceramic capacitor according to claim 1, wherein the second direct plating layer extends onto a portion of the first main surface.

20. A multilayer ceramic capacitor comprising:
a multilayer body including a plurality of laminated dielectric layers, a first main surface and a second main surface facing away from each other in a lamination direction of the plurality of laminated dielectric layers, a first side surface and a second side surface facing away from each other in a width direction orthogonal or substantially orthogonal to the lamination direction, and a third side surface and a fourth side surface that face away from each other in a length direction orthogonal or substantially orthogonal to the lamination direction and the width direction; and
at least four outer electrodes on two or more of six surfaces including the first main surface, the second main surface, the first side surface, the second side surface, the third side surface, and the fourth side surface; wherein
each of the at least four outer electrodes includes:
a direct plating layer covering at least a portion of one of the first side surface, the second side surface, the third side surface, and the fourth side surface;
a main surface electrode covering at least a portion of the first main surface;
an upper plating layer; and
a front plating layer.

21. The multilayer ceramic capacitor according to claim 20, wherein a lower plating layer is between the upper plating layer, and the direct plating layer and the main surface electrode to coat the direct plating layer and the main surface electrode.

22. The multilayer ceramic capacitor according to claim 20, wherein a main metallic component of the direct plating layer is identical to a main metallic component of the lower plating layer.

23. The multilayer ceramic capacitor according to claim 20, wherein a sum of a thickness of one of the at least four outer electrodes in the lamination direction and a thickness of the multilayer body in the lamination direction is about 100 μm or less.

24. The multilayer ceramic capacitor according to claim 20, wherein a sum of a thickness of any one of the at least four outer electrodes in the lamination direction and a thickness of the multilayer body in the lamination direction is about 60 μm or less.

25. The multilayer ceramic capacitor according to claim 20, wherein the main surface electrode covers at least a portion of the direct plating layer.

26. The multilayer ceramic capacitor according to claim 20, wherein the main surface electrode covers at least a portion of any one of the first side surface, the second side surface, the third side surface, and the fourth side surface.

27. The multilayer ceramic capacitor according to claim 20, wherein the direct plating layer extends onto a portion of the third side surface.

28. The multilayer ceramic capacitor according to claim 20, wherein the direct plating layer extends onto a portion of the fourth side surface.

29. The multilayer ceramic capacitor according to claim 20, wherein the direct plating layer extends onto a portion of the second side surface.
